(19) United States
(12) Patent Application Publication
(10) Pub. No.: US 2012/0304840 A1
(43) Pub. Date: Dec. 6, 2012

(54) SHEET PERFORATION DEVICE AND ITS CONTROL METHOD

(75) Inventors: Hisashi Kobayashi, Gunma (JP); Yoshio Chigira, Gunma (JP)

(73) Assignee: MAX CO., LTD., Tokyo (JP)

(21) Appl. No.: 13/586,295

(22) Filed: Aug. 15, 2012

Related U.S. Application Data
(62) Division of application No. 12/438,463, filed on Feb. 23, 2009.

(30) Foreign Application Priority Data
Aug. 24, 2006 (JP) 2006-228157
Oct. 17, 2006 (JP) 2006-282740

(51) Int. Cl. B26D 5/02; B26D 5/08

(52) U.S. Cl. 83/13; 83/70

(57) ABSTRACT

A paper-sheet punching device shown in FIG. 4 includes a motor 22 for driving a reciprocatingly movable punching blade 21 and is provided with a punching process unit 20′ for punching two or more holes at one end of paper-sheets 3 and with a CPU 55 for controlling this unit. The CPU 55 detects whether the punching blades 21 rushes into a home position in which the stop position of the punching blades 21 is allowed, executes reverse rotation brake control on the motor 22 for a predetermined period of time from the point of time when the punching blades 21 rushes into the home position, and prolongs the reverse rotation brake control on the motor 22 after the punching blades 21 reaches a predetermined position. It becomes possible to stop the punching blade within the home position when the punching blade stops.

### CROSS-REFERENCE TO RELATED APPLICATIONS

This application is a divisional of U.S. patent application Ser. No. 12/438,463, filed Feb. 23, 2009, which is a national stage application filed under 35 USC 371 based on International Application No. PCT/JP2007/065912, filed Aug. 15, 2007, and claims priority under 35 USC 119 of Japanese Patent Application No. 2006-228157, filed Aug. 24, 2006 and Japanese Patent Application No. 2006-282740, filed Oct. 17, 2006.

### TECHNICAL FIELD

This invention relates to a paper-sheet punching device and a control method thereof preferably applied to a device for punch-processing recording paper-sheets outputted from a copy machine or a print machine. In more detail, it is constituted such that there is provided with control means executing control for punching two or more holes at one end of each of the paper-sheets by means of a reciprocatingly movable punching blade; it is detected whether or not the punching blade rushes into a home position during a stop control of the punching blade; reverse rotation brake of a motor for the punching blade drive is executed until a predetermined period of time elapses from a point of time when the punching blade rushes into the home position; the reverse rotation brake of the motor is prolonged based on time monitoring in a case in which the punching blade reaches a predetermined position within a predetermined period of time; accordingly, it is made possible to stop the punching blade in the home position and at the same time; it is made possible for the punching blade to be stop-controlled within the home position against the environment change in a case in which the thickness of the paper-sheets is thin and also in a case in which the thickness thereof is thick or the like and against the change in the brake performance.

### BACKGROUND ART

In recent years, a case in which a copy machine, a print machine or the like for black-and-white use and for color use is used by combining a punching device has occurred frequently. According to this kind of paper-sheet punching device, recording paper-sheet after the picture formation is received, and then, at a downstream side of the paper-sheet, perforation is executed using a punch function. The paper-sheets after the perforation are aligned once again, and a binding process of a ring band or the like is performed automatically by utilizing the holes thereof.

In the punching device, a punching process unit is provided and in this punching process unit, a Direct Current (DC) motor is used, as well as there is employed one stroke operation of the punching blade by converting rotation movement to reciprocating motion. In order to always stop the punching blade at a regular position (home position) by a short time operation, braking force is adjusted depending on a short brake control after the motor is turned on and the punching blade reaches the lowest point thereof.

For example, in connection with this kind of a punching device, a paper-sheet punching device, a paper-sheet processing device and an image forming system have been disclosed in Japanese Patent Application Publication No. 2004-345834. According to this paper-sheet punching device, when using a brushless motor as the punch motor, normal rotation or reverse rotation control of the motor is executed based on a rotation direction flag and at the same time, a pulse count for measuring elapsed time starts immediately after the motor rotation. After a predetermined period of time has elapsed, the brake start pulse is calculated and the motor brake control is executed at a point of time when the pulse count value becomes the brake start pulse thereof. When employing such a motor control method, it can be said that accuracy of the motor stop can be improved even when using a brushless motor as the punch motor.

Also, a paper-sheet punching device, a paper-sheet processing device and an image forming system have been disclosed in Japanese Patent Application Publication No. 2005-014160. According to this paper-sheet punching device, it is constituted such that the drive amount of a motor executing the punching operation is detected and the thickness of the paper-sheets to be punched is detected as well as the stop operation of the motor executing the punching operation is controlled in response to this thickness of the paper. When employing such a motor control method, it can be said that the accuracy of the motor stop can be improved even if the thickness of the paper changes.

Further, a paper-sheet punching device, a paper-sheet processing device and an image forming system have been disclosed in Japanese Patent Application Publication No. 2005-075550. According to this paper-sheet punching device, when punching the paper-sheets by a punching blade, it is constituted such that the position of the punching blade is detected on an occasion of the stop of the motor or before the stop thereof, the position and a desired position are compared, and if the position of the punching blade is deviated from the desired position, the motor is controlled to be re-driven. When employing such a motor control method, it can be said that accuracy of the motor stop can be improved even when using a brushless motor as the punch motor. Meanwhile, according to a high-speed punching blade unit of past system, as seen in the above-mentioned three publications, it is constituted such that the DC motor is used and when operating this DC motor, one punch operation is completed in a short time.

However, it is insufficient if merely the start timing of the brake is changed, if only employing stop operation control in response to the thickness of the paper-sheets or if only executing the re-drive or the reverse rotation drive by discriminating positions before and after with respect to the desired motor stop position, and owing to an influence of the mechanical time constant (delay coefficient: of the DC motor, the punching blade unit does not completely stop at the home position and stops at a position deviated from the home position.

Also, when the punch operation is continued for a long time, the motor becomes in a high temperature. Thus, the braking force during the brake is decreased. In other words, action of braking becomes worse. Consequently, when employing a control method in which a reverse rotation brake is activated only during a calculated period of time, the stop is not executed within the allowable range of the home stoppage and there is a fear that a phenomenon in which the punching blade homes out may occur caused by a fact that the motor rotates too much.

In order to prevent the over rotation of the motor at such a home position, a control referred to as a short brake is employed. Even if this short brake control is executed, there sometimes happens, owing to the paper thickness of the paper-sheets applied with the punching, a case in which the motor does not stop completely within the home position and rotates too much or a case in which the motor does not reach the home position.

In particular, it is very difficult to stop a punching blade having a high speed operation specification within the home position in which the allowable region for the home stop is narrow with excellent repeatability. Incidentally, there is a fear in which it happens that the punching blade stops before the home position if the brake is activated too earlier and it happens that the punching blade passes over the home position if the brake is delayed.

### DISCLOSURE OF THE INVENTION

A first paper-sheet punching device relating to the present invention is a device for punching a hole through a predetermined paper-sheet, and is provided with punching means including a motor for driving a reciprocatingly movable punching blade and punching two or more holes at one end of the paper-sheet and control means for controlling the punching means. It is characterized that the control means sets divisional control intervals by separating a specific interval during a period of return path time of the punching blade into a plurality of intervals, sets a period of target passing time of the punching blade for each of the divisional control intervals or for every set-group of the divisional control intervals, measures a period of actual passing time of the punching blade for each of the divisional control intervals, compares the period of target passing time set for the divisional control interval and the period of measured passing time obtained by the actual measurement, and controls, based on a result of the comparison, drive or brake of the motor for the punching blade drive in a next interval of the divisional control intervals or in a next set-group of the divisional control intervals. According to the first paper-sheet punching device, when punching a hole through predetermined paper-sheet, the punching means includes a motor for driving the punching blade and it becomes in a state in which two or more holes are punched at one end of the paper-sheets by reciprocatingly moving the punching blade. The control means controls the punching means. Based on the assumption of this, it becomes in a state in which the control means sets divisional control intervals by separating a specific interval during a period of return path time of the punching blade into a plurality of intervals, sets a period of target passing time of the punching blade for each of the divisional control intervals or for every set-group of the divisional control intervals, measures a period of actual passing time of the punching blade for each of the divisional control intervals, compares the period of target passing time set for the divisional control interval and the period of measured passing time obtained by the actual measurement, and controls, based on a result of this comparison, the drive or the brake of the motor for the punching blade drive in a next interval of the divisional control intervals or in a next set-group of the divisional control intervals.

Consequently, the speed control during the period of return path time of the punching blade can be executed with high definition and also with high resolution, so that it becomes possible to avoid a situation in which the punching blade stops before a regular position or the punching blade stops beyond the regular position. Thus, in a case in which the paper-sheets are thick and also in a case in which they are thin, it is possible to stop the punching blade after the punch at a regular position with excellent repeatability. Consequently, it is possible for the punching blade to be moved reciprocatingly by always making a regular position as a reference.

A first control method of a paper-sheet punching device relating to the present invention is a control method of a paper-sheet punching device including a motor for driving a reciprocatingly movable punching blade and punching a hole through a predetermined paper-sheet, characterized in that the control method comprises a step of setting divisional control intervals by separating a specific interval during a period of return path time of the punching blade into a plurality of intervals, a step of setting a period of target passing time of the punching blade for each of the divisional control intervals or for every set-group of the divisional control intervals, a step of measuring a period of actual passing time of the punching blade for each of the divisional control intervals, a step for comparing the period of target passing time set for the divisional control interval and the period of measured passing time obtained by the actual measurement, and a step of controlling, based on a result of the comparison, drive or brake of the motor for the punching blade drive in a next interval of the divisional control intervals or in a next set-group of the divisional control intervals.

According to the first control method, when punching a hole through predetermined paper-sheet, the speed control during the period of return path time of the punching blade can be executed with high definition and also with high resolution, so that it becomes possible to avoid a situation in which the punching blade stops before a regular position or the punching blade stops beyond the regular position.

A second paper-sheet punching device relating to the present invention is a device for punching a hole through a predetermined paper-sheet, and is provided with punching means including a motor for a punching blade drive that drives a reciprocatingly movable punching blade and punching two or more holes at one end of the paper-sheet, and control means for controlling the punching means. It is characterized that the control means detects whether the punching blade rushes into a home position in which the stop position of the punching blade is allowed, executes a reverse rotation brake of the motor during a period of predetermined time from a point of time when the punching blade rushes into the home position, and prolongs the reverse rotation brake based on time monitoring when the punching blade reaches a predetermined position in the period of predetermined time.

According to the second paper-sheet punching device, if punching a hole through predetermined paper-sheet, when the control means controls the punching means and when two or more holes are punched at one end of the paper-sheet, the motor for the punching blade drive is driven and the punching blade is moved reciprocatingly. Based on the assumption of this, the control means detects whether the punching blade rushes into a home position in which the stop position of the punching blade is allowed, executes a reverse rotation brake of the motor during a period of predetermined time from the point of time when the punching blade rushes into the home position, and prolongs the reverse rotation brake based on time monitoring when the punching blade reaches a predetermined position in the period of predetermined time.

Consequently, the speed for bringing the punching blade into a stop thereof can be converged to zero quickly, so that it becomes possible to stop the punching blade within the home position with excellent repeatability. Thus, in a case in which the thickness of the paper-sheets is thin and also in a case in which the thickness thereof is thick, it becomes possible to realize a reciprocating operation of the punching blade by making the home position as a reference and it becomes possible to provide a paper-sheet punching device with high accuracy and also with high reliability.

A second control method of a paper-sheet punching device relating to the present invention is a control method of a paper-sheet punching device which moves a punching blade reciprocatingly by driving a motor for the punching blade drive when punching two or more holes at one end of a paper-sheet, characterized in that the control method comprises a step of detecting whether the punching blade rushes into a home position in which the stop position of the punching blade is allowed, a step of executing a reverse rotation brake of the motor during a period of predetermined time from the detected point of time when the punching blade rushes into the home position, and a step of prolonging the reverse rotation brake based on time monitoring when the punching blade reaches a predetermined position in the period of predetermined time.

According to the second control method of the paper-sheet punching device, when punching a hole through predetermined paper-sheet, the speed for bringing the punching blade into a stop thereof can be converged to zero quickly, so that it becomes possible to stop the punching blade within the home position with excellent repeatability. Consequently, it becomes possible for the punching blade to be stop-controlled within the home position with excellent repeatability against the environment change in a case in which the thickness of the paper-sheets is thin and also in a case in which the thickness thereof is thick or the like and against the change in the brake performance.

### BRIEF DESCRIPTION OF THE DRAWINGS

FIG. 1 is a conceptional diagram showing a constitution example of a binding device 100 to which a paper-sheet punching device as an embodiment relating to the present invention is applied;

FIGS. 2(A) to 2(D) are process diagrams showing a function example of the binding device 100;

FIG. 3 is a partially crushed side cross-section view showing a constitution example of a punching process unit 20′;

FIG. 4 is a block diagram showing a constitution example of a control system of the punching process unit 20′;

FIGS. 5(A) to 5(E) are waveform diagrams showing state examples of a punching blade unit 202 and control examples of a motor 22;

FIGS. 6(A) to 6(E) are conceptional diagrams showing state examples of punching blades 21 thereof;

FIGS. 7(A) to 7(F) are diagrams showing a punching blade stroke example of one cycle in the punching blade unit 202;

FIGS. 8(A) to 8(C) are timing charts showing a motor control example in a return path stroke of the punching blades 21;

FIG. 9 is a flowchart showing a control example of the punching process unit 20′ (No. 1 thereof) relating to a first embodiment;

FIG. 10 is a flowchart showing the control example of the same punching process unit 20′ (No. 2 thereof);

FIG. 11 is a flowchart showing the control example of the same punching process unit 20′ (No. 3 thereof);

FIGS. 12(A) to 12(C) are time charts showing a reverse rotation brake control example during a period of stop time of a punching blade relating to a second embodiment;

FIGS. 13(A) and 13(B) are time charts showing a reversal detection example during the period of stop time of the punching blade;

FIG. 14 is a flowchart showing a control example of the punching process unit 20′ (No. 1 thereof) relating to the second embodiment;

FIG. 15 is a flowchart showing the control example of the same punching process unit 20′ (No. 2 thereof);

FIG. 16 is a flowchart showing the control example of the same punching process unit 20′ (No. 3 thereof);

FIG. 17 is a flowchart showing the control example of the same punching process unit 20′ (No. 4 thereof);

FIGS. 18(A) to 18(C) are time charts showing a usual operation example of a reverse rotation brake during a period of stop time of the punching blade; and

FIGS. 19(A) and 19(B) are operation time charts showing a comparison example between prolongation existence and nonexistence of the reverse rotation brake during the period of stop time of the punching blade.

### BEST MODE FOR CARRYING OUT THE INVENTION

The present invention has a first object to provide a paper-sheet punching device and a control method thereof in which it is possible to stop the punching blade within a predetermined home position with excellent repeatability during a period of stop time of the punching blade and it is possible for the punching blade to move reciprocatingly by making the home position as a reference also in a case in which the thickness of the paper-sheets is thin and also in a case in which the thickness thereof is thick.

The present invention has a second object to provide a paper-sheet punching device and a control method thereof in which it is possible to realize a speed control with high definition and also with high resolution during a period of return path time of the punching blade and it is possible for the punching blade to move reciprocatingly with excellent repeatability by making the home position as a reference in a case in which the paper-sheets are thick and also in a case in which they are thin.

Hereinafter, the following will describe a paper-sheet punching device and a control method thereof relating to embodiments of the present invention with reference to the drawings.

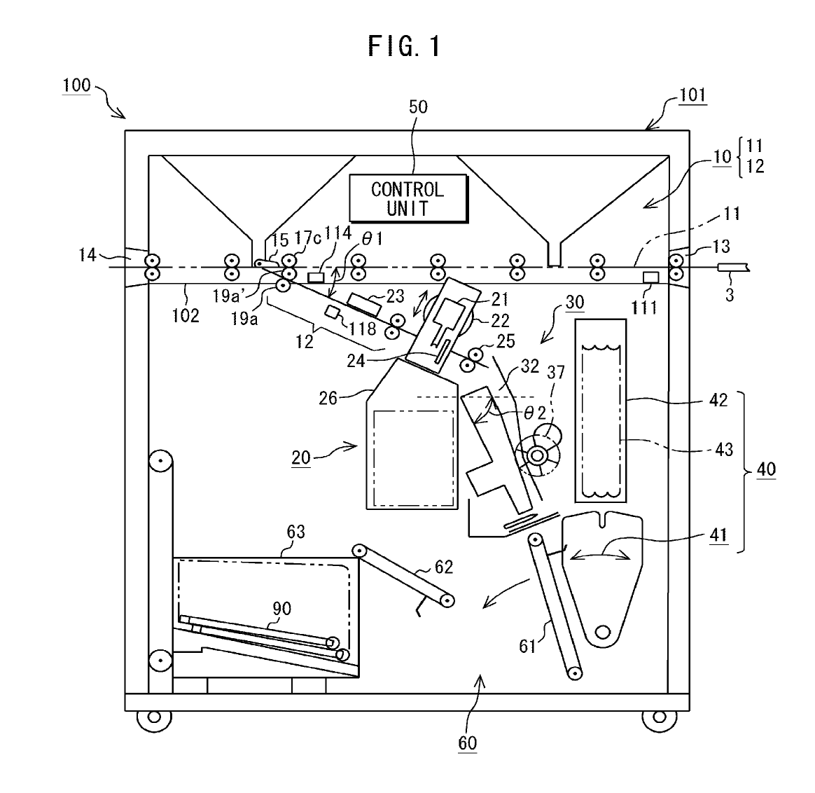

FIG. 1 is a conceptional diagram showing a constitution example of a binding device 100 to which a paper-sheet punching device as an embodiment relating to the present invention is applied.

The binding device 100 shown in FIG. 1, to which the paper-sheet punching device is applied, is a device that applies punching processing to a recording paper(hereinafter, merely referred to as paper-sheet 3) outputted from the copy machine or the print machine and thereafter, performs output thereof after the binding process by a predetermined binding component (commodity) 43. Of course, a paper-sheet punching device provided with a function of perforating a hole on a predetermined paper-sheet 3 and outputting the paper without any change may be applied to it. In case of paper-sheets for which the punching operation is finished, they may be supplied to a binding device (binding process unit) without passing them through the punching process.

The binding device 100 includes a device body portion (housing) 101. It is preferable for the binding device 100 to be used in conjunction with a copy machine, a printing machine (picture forming device) or the like, and the device body portion 101 has a comparable height as that of a copy machine, a printing machine or the like.

A paper-sheet transport unit 10 is provided in a device body portion 101. The paper-sheet transport unit 10 includes a first transport path 11 and a second transport path 12. The transport path 11 includes a paper-feed inlet 13 and an outlet 14, and has a through pass function for transporting the paper-sheet 3 drawn from the paper-feed inlet 13 toward the outlet 14 that becomes the predetermined position.

Here, the through pass function means a function that the transport path 11 positioned between a copy machine, a printing machine or the like on the upstream side and other paper-sheet handling device on the downstream side directly delivers the paper-sheet 3 from the copy machine, the printing machine or the like to the other paper-sheet handling device. In a case in which the through pass function is selected, the acceleration process of the transport rollers, the binding process or the like is omitted. The paper-sheet 3, usually, in case of one-side copy, is delivered in a state of the face down. A paper feed sensor 111 is mounted on the paper-feed inlet 13 so as to output a paper feeding detection signal S11 to a control unit 50 by detecting a front edge of the paper-sheet 3.

The transport path 12 has a switchback function by which the transport path is switchable from the transport path 11. Here, the switchback function means a function that decelerates and stops the transport of the paper-sheet 3 at a predetermined position of the transport path 11, thereafter, switches the transport path of the paper-sheet 3 from the transport path 11 to the transport path 12, and also, delivers the paper-sheet 3 in the reverse direction. A flap 15 is provided in the transport path 11 so as to switch the transport path from the transport path 11 to the transport path 12.

Also, there is provided at a switch point between the transport path 11 and the transport path 12 with three cooperative transport rollers 17c, 19a′, 19a. The transport rollers 17c and 19a rotate clockwise and the transport roller 19a′ rotates counterclockwise. For example, it is constituted such that the transport roller 19a′ is a drive roller and the transport rollers 17c and 19a are driven rollers. The paper-sheet 3 taken by the transport rollers 17c and 19a′ decelerates and stops, but when the flap 15 is changed over from the upper side to the lower side, it is transported to the transport path 12 by being fed by the transport rollers 19a′ and 19a. A paper-sheet detecting sensor 114 is disposed just before three cooperative transport rollers 17c, 19a′ and 19a, and detects the front end and the rear end of the paper-sheet, and a paper-sheet detection signal S14 is outputted to the control unit 50.

A punching process unit 20 that becomes one example of a perforating means is arranged on the downstream side of the transport path 12. In this embodiment, it is designed so as to have a predetermined angle between the above-mentioned transport path 11 and transport path 12. For example, a first depression angle θ1 is set between a transport surface of the transport path 11 and a paper-sheet surface to be perforated of the punching process unit 20. Here, the paper-sheet surface to be perforated means a surface where holes are perforated in the paper-sheet 3. The punching process unit 20 is arranged so that the paper-sheet surface to be perforated is set to a position having the depression angle 01 on the basis of the transport surface of the transport path 11.

In the punching process unit 20, two or more holes for the binding are perforated at the one end of the paper-sheet 3 which switchbacks from the transport path 11 and transported by the transport path 12. The punching process unit 20 includes, for example, a motor 22 that drives reciprocatingly operable punch blades 21. The paper-sheet 3 is perforated by the punch blades 21 driven by a motor 22 for every sheet. A DC motor is used for the motor 22. Table 1 shows an operation mode of the motor 22.

TABLE 1
Motor Operation Modes

| | |
|---|---|
| Positive Rotation | ON (CW) |
| Reverse Rotation | ON (CCW) |
| short brake | short-circuit between terminals |
| free-run | OFF |

In Table 1, the “positive rotation” mode means an operation of rotating the motor 22 forward (ON (CW)) by applying a voltage of predetermined polarity between the terminals of the motor 22. The “reverse rotation” mode means an operation of rotating the motor 22 reversely (ON (CCW)) by applying a voltage of reverse polarity between the terminals the motor 22. The “short brake” mode means an operation in which the motor 22 is cut off from the power supply so as to be short-circuited (shorted) between the terminals thereof, the motor 22 is functioned as a generator, and braking is executed by utilizing an armature reaction thereof (short-circuit braking). The “free-run” mode means an operation in which the motor 22 is cut off from the power supply so as to be opened between the terminals thereof and rotation is carried out corresponding to the load torque.

An openable and closable fence 24 that becomes a reference of the perforation position is provided in the punching process unit 20 and is used so as to attach the paper-sheet 3. Further, a side jogger 23 is provided in the punching process unit 20, and the posture of the paper-sheet 3 is corrected. For example, a front edge of the paper-sheet 3 is made to be attached uniformly to the openable and closable fence 24. The fence 24 becomes a positional reference at the time of aligning the paper-sheet edge portion. A paper-sheet detecting sensor 118 is disposed on the near side of the side jogger 23, the front end and the rear end of the paper-sheet 3 are detected, and a paper-sheet detection signal S18 is outputted to the control unit 50.

The punching process unit 20 is stopped by attaching the paper-sheet 3 to the fence 24 and thereafter, the front edge of the paper-sheet 3 is perforated. It should be noted that there is provided with a punch scrap storing unit 26 on the lower side of the punching processing main body and the punch scrap cut off by the punch blades 21 is made to be stored therein. There is provided with a paper output roller 25 which becomes one example of the paper-sheet discharge means on the downstream side of the punching process unit 20 and the paper-sheet 3′ after the paper-sheet perforation is made so as to be transported to the unit of the succeeding stage.

There is arranged on the downstream side of the punching process unit 20 with the binder paper alignment unit 30 and a plurality of paper-sheets 3′ which are paper-outputted from the punching process unit 20 are made so as to be held (stored) temporarily in a state in which the hole positions thereof are aligned. The binder paper alignment unit 30 is arranged so as to set the paper-sheet holding surface at the position having a second depression angle 82 by making a transport surface of a transport unit 11 to be a reference. Here, the paper-sheet hold surface means the surface that holds paper-sheet 3′ where the holes are perforated. In the embodiment, a relation between the depression angle θ1 and the depression angle θ2 is set as θ1<θ2. With respect to the depression angle θ1, it is set as 0°<θ1<45° and with respect to the depression angle θ2, it is set as 0°<θ2<90° respectively. This setting is for miniaturizing a width of the main body device 101 and for linearly transporting the paper-sheet 3′ under this condition.

The binder paper alignment unit 30 has a paper-sheet guide pressing function and guides the paper-sheet 3 to a predetermined position when the paper proceeds and after the paper proceeding is completed, the rear end of the paper-sheet 3′ is made so as to be immobilized. Also, the binder paper alignment unit 30 has a paper-sheet front edge alignment function and is operated so as to guide the front end of the paper-sheet 3′, at the time of the paper proceeding, to a proper position of a multiple paddles shaped rotating member (hereinafter, referred to as paddle roller 37) for aligning the front end and side end of the paper-sheet 3′ in the reference positions.

On the downstream side of the binder paper alignment unit 30, there is arranged a binding process unit 40 and it is constituted such that a booklet 90 is produced by binding a plurality of paper-sheets 3′ aligned by the unit 30 using the binding component 43. The booklet 90 means a bundle of bound paper-sheets 3″ with which the binding component 43 is fitted.

In this embodiment, the binding process unit 40 includes a movement mechanism 41. The movement mechanism 41 passes so as to rotate reciprocatingly between the positions in the paper-sheet transporting direction of the binder paper alignment unit 30 and in the transporting direction perpendicular to the aforementioned paper-sheets transport unit 10. The binding process unit 40 includes a binder (binding component) cassette 42. In the binder cassette 42, there is set a plurality of binding components. The binding components are, for example, injection-molded and a plurality of kinds thereof is prepared corresponding to the thickness of the bundle of paper-sheets 3″.

The movement mechanism 41, for example, pulls out one piece of binding component 43 from the binder cassette 42 at the position perpendicular to the transporting direction of the paper-sheets transport unit 10 and holds it and in this state, it rotates to the position from which the paper-sheet transporting direction of the binder paper alignment unit 30 can be looked over. At this position, the binding process unit 40 receives a bundle of paper-sheets 3″ whose punch holes are position-determined from the binder paper alignment unit 30 and fits the binding component 43 into the punch holes thereof, and a binding process is executed (automatic book-making function).

In the downstream side of the binding process unit 40, an output unit 60 is arranged and the output processing for the booklet 90 produced by the binding process unit 40 is carried out. The output unit 60 is constituted so as to include, for example, a first belt unit 61, a second belt unit 62 and a stacker 63.

The belt unit 61 is constituted so as to receive the booklet 90 that is dropping from the paper alignment unit 30, and to switch the delivery direction thereof. For example, it is constituted such that the belt unit main body is turned around toward a predetermined output direction from the position from which the paper-sheet transporting direction of the paper alignment unit 30 can be looked over.

The belt unit 62 is constituted so as to receive the booklet 90 whose delivery direction is switched by the belt unit 61 and to transport it in the relay manner. The stacker 63 constitutes one example of the booklet storing unit and is constituted so as to accumulate the booklets 90 transported by the belt units 61 and 62. In this manner, the binding device 100 to which the paper-sheet punching device is applied is constituted.

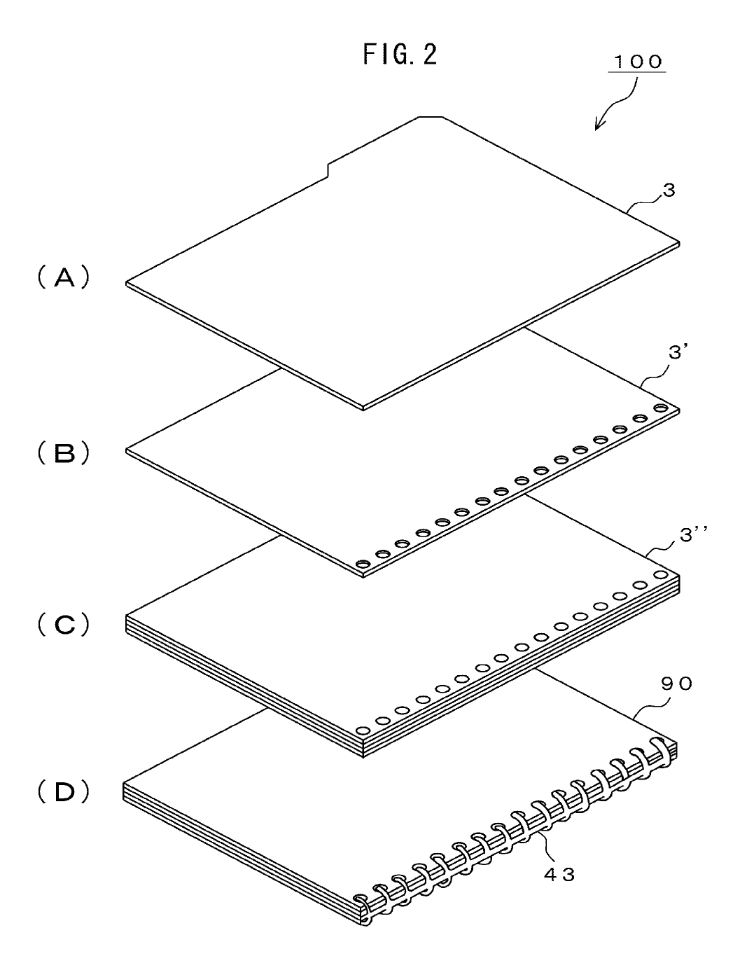

The following will describe a paper-sheet processing method relating to the present invention with reference to FIGS. 2(A) to 2(D).

The paper-sheet 3 shown in FIG. 2(A) is one paper-fed from the upstream side of the binding device 100. It is one for which punch holes are not perforated. The paper-sheet 3′ is transported directed to a predetermined position of the transport path 11 shown in FIG. 1 and is decelerated and stopped at a predetermined position of the transport path 11. Thereafter, the transport path of the paper-sheet 3′ is switched from the transport path 11 to the transport path 12 and also, the paper-sheet 3′ is delivered in the reverse direction and is transported to the punching process unit 20.

In the punching process unit 20, as shown in FIG. 2(B), a predetermined number of holes for the binding is perforated at one end of the paper-sheet 3. The paper-sheet 3′ formed with the hole portion for the binding is transported to the binder paper alignment unit 30. When the paper-sheets 3′ reaches preset paper-sheet quantity and becomes a paper-sheet bundle 3″ shown in FIG. 2(C), it is constituted in the binder paper alignment unit 30 such that the positions of the hole portions for the binding thereof are aligned and the binding component 43 is inserted into the hole portions thereof under the cooperation of the binding process unit 40. Thus, it is possible to obtain the booklet 90 as shown in FIG. 2(D) into which the binding component 43 is inserted.

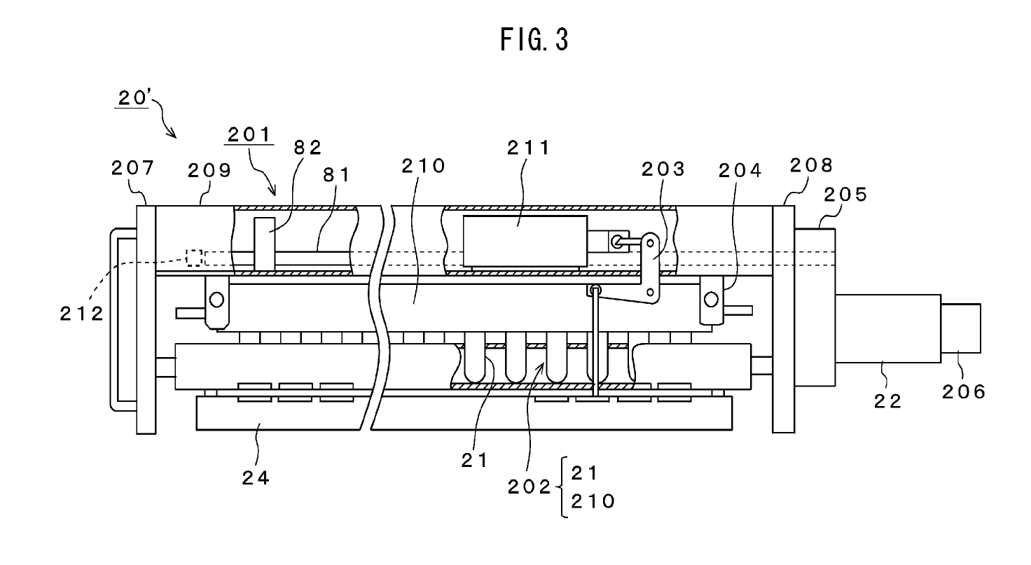

The following will describe the punching process unit 20′ in which a drive system of the punching blades 21 is unitized with reference to FIG. 3. The punching process unit 20′ shown in FIG. 3 is constituted by including the punching blades 21, the fence 24, a main body portion 201, a punching blade unit 202, a link member 203, a drive mechanism 204 and an encoder 206.

The main body portion 201 has a bridge shape in which a cross-link member 209 is supported by a front surface plate 207 and a backboard 208. The main body portion 201 is formed by bending and press-processing an iron plate at a desired position. The cross-link member 209 has a box shape, and the drive mechanism 204 is provided at the cross-link member 209.

The drive mechanism 204 is constituted by the motor 22, a cam shaft 81, cams 82, a bias member (not shown) and a gear unit 205. The cams 82 are attached to the cam shaft 81 at least by two places. The drive mechanism 204 drives the punching blade unit 202 by rotating the cams 82. For example, the punching blade unit 202 includes a body portion 210 mounted with a plurality of punching blades 21 in series. The body portion 210 is engaged freely movably with the cams 82 which rotates through the cam shaft 81 of the drive mechanism 204 with it being biased in a fixed direction (down direction in this example) by the bias member such as a coil spring which is not shown.

The gear unit 205 includes a deceleration gear which is not shown. The motor 22 is engaged with the deceleration gear, the deceleration gear is attached to the cam shaft 81 and the cams 82 rotate through the cam shaft 81. The number of teeth for a gear (small) attached to the motor 22 is “12”, the number of teeth for a gear (large) attached to the cam shaft 81 is “59” and a gear ratio is “1:4.92”.

The cams 82 convert the rotation movement of the motor 22 to an up and down reciprocating drive of the body portion 210 which is biased in a fixed direction by a coil spring or the like. The up and down reciprocating motion of the body portion 210 becomes the up and down reciprocating motion of the punching blades 21. The up and down reciprocating motion is given by a cam drive force through the cam shaft 81 by overcoming a bias force of the above-mentioned coil spring or the like. Thus, it is constituted such that the punching blade unit 202 is reciprocatingly driven up and down depending on the drive mechanism 204. It becomes possible to punch a predetermined number of holes through the paper-sheets 3 having a predetermined thickness by the up and down reciprocating motion of the punching blades 21.

On the inside of the above-mentioned cross-link member 209, a solenoid 211 is arranged other than the cam shaft 81 of the drive mechanism 204. To the solenoid 211, the link member 203 is attached movably. To the other edge of the link member 203, the fence 24 is attached. The fence 24 has a long plate shape which is longer than the length of the paper-sheets 3, and the reference position of the punching blades with respect to the paper-sheets 3 is set. The fence 24 is arranged on the down side of the punching blade unit 202. It is constituted such that the link member 203 drives the fence 24 up and down (closing and opening gate operation) based on the reciprocating motion by means of the solenoid 211.

To a rotation axis of the above-mentioned motor 22, there is attached the encoder 206 which detects the motor rotation speed and outputs a speed detection signal (speed detection information) S23. The encoder 206 includes a transmissive optical sensor and an impeller which is attached to the motor axis. At an impeller, for example, there are radially arranged slits of thirty two places along the radius direction around a rotation axis. The encoder 206 outputs the number of pulses Px=157 (gear ratio 4.92×number of slits 32) per one rotation of a cam.

In this example, at the above-mentioned impeller, there is provided, other than slits of thirty two places, with another slit which lies on a different diameter circle, and the encoder 206 generates a counted value showing one time of the reciprocating movement of the punching blade per one rotation of the cam.

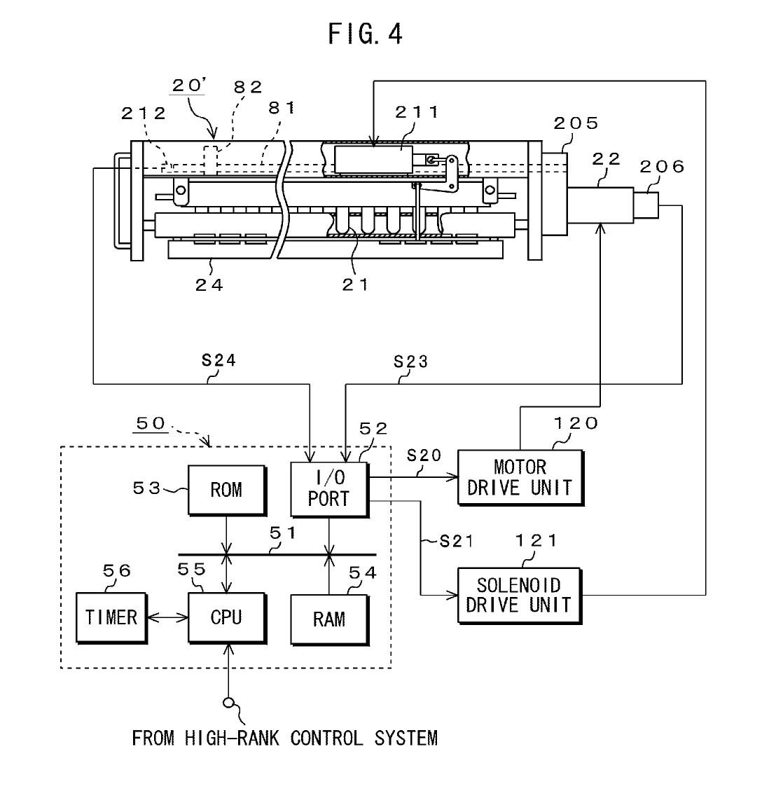

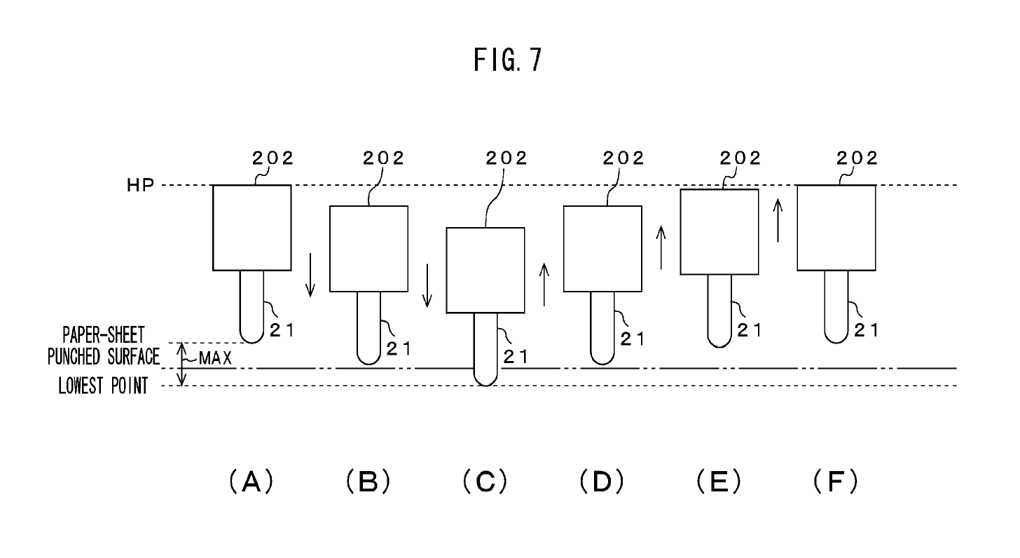

On the inside of the cross-link member 209, there is disposed a position sensor 212 which detects the punching blade unit 202 at a fixed position and outputs a position detection signal S24 showing whether or not the unit 202 returns to the home position HP. Here, the home position HP means a specific stop position range in which the front edges of the punching blades 21 are at positions apart from the paper-sheets 3, do not become an obstacle to the paper-sheets 3 into which the punching blades 21 are inserted, and do not become an obstruct for one reciprocating operation of the next punch (see FIGS. 7(E) to 7(F)). In this manner, the punching process unit 20′ is constituted. The speed detection signal S23 and the position detection signal S24 are outputted to the control unit 50 shown in FIG. 4.

A control system of the punching process unit 20′ shown in FIG. 4 is constituted by including the control unit 50, a motor drive unit 120 and a solenoid drive unit 121. The control unit 50 constitutes one example of the control means and includes a system bus 51. To the system bus 51, an I/O port 52, an ROM 53, an RAM 54 and a CPU 55 are connected.

To the I/O port 52, the position sensor 212 is connected and outputs the position detection signal S24 by detecting a regular position (hereinafter, referred to as the home position HP) of the punching blades 21. For the position sensor 212, there is used a transmissive optical sensor. To the I/O port 52, the encoder 206, which becomes one example of a speed sensor, is connected other than the position sensor 212, and outputs the speed detection signal S23 to the CPU 55 by detecting the motor rotation speed. The CPU 55 becomes in a state of monitoring the speeds of the punching blades 21 in an approach path and in a return path based on the speed detection signal S23.

To the I/O port 52, the system bus 51 is connected, and to the system bus 51, the ROM 53 is connected. In the ROM 53, there is stored a speed control program during the period of return path time of the punching blades. The contents thereof are: a step of setting the divisional control intervals (hereinafter, indicated as the intervals #i (i=1 to n)) by separating a specific interval during the period of return path time of the punching blades into a plurality of intervals; a step of setting a period of the target passing time of the punching blades 21 (hereinafter, referred to as setting values Th1, Th2, ••• •••) for each of the intervals #i or for every set-group of the intervals #i; a step of measuring a period of the actual passing time Tx of the punching blades 21 (measured passing time: Time A) for each of the intervals #i; a step of comparing the setting value Th1 or the like which is set for the interval #i and the passing time Tx which is obtained by the actual measurement; and a step for controlling, based on a result of the comparison, a drive or a brake (brake) of the motor 22 for the punching blade drive in the next interval #i+1.

The CPU 55 controls a drive or a brake of the motor 22 based on a speed control program during the period of return path time of the punching blades, which is read out from the ROM 53. For example, it is constituted such that the CPU 55 brakes the motor 22 for the punching blade drive in the next interval #i+1 by a short brake when the passing time Tx obtained by the actual measurement is shorter than the setting value Th1 or the like, and ON-controls and drives the motor 22 for the punching blade drive in the next interval #i+1 when the passing time Tx is longer than the setting value Th1 or the like.

Also, it is constituted such that to the CPU 55, the motor drive unit 120 is connected through the I/O port 52, receives the motor drive signal S20 from the CPU 55, and drives the motor 22 based on this motor drive signal S20 to drive the punching blade unit 202 reciprocatingly up and down through the drive mechanism 204. For example, when 157 pieces of pulse signals based on the motor drive signal S20 are outputted from the motor drive unit 120 to the motor 22, the deceleration gear turns fully around. In this example, when the deceleration gear turns fully around, the cams 82 rotate fully around one time through the cam shaft 81 attached to the deceleration gear, and the punching blades 21 start from the home position HP, punch the paper-sheets and return to the home position HP again.

In the above-mentioned ROM 53, other than the speed control program during the period of return path time of the punching blades, there is stored a program for calculating the reverse rotation braking amount thereof (hereinafter, referred to as reverse rotation brake retain time Y) when, for example, braking the motor by adding a force in the direction in which the motor 22 rotates reversely is called as the reverse rotation brake. The RAM 54 is used as a work memory when calculating the reverse rotation brake retain time Y. A general-purpose memory is used for the RAM 54 and it is constituted such that data of calculation midway is stored therein temporarily. Other than a program for this reverse rotation brake amount calculation, the CPU 55 calculates the reverse rotation brake retain time Y based on the speed detection signal S23 during the period of return path time of the punching blades 21, and executes the motor reverse rotation brake control based on the reverse rotation brake retain time Y at the point of time when a regular position of the punching blades 21 is detected. The speed detection signal S23 during the period of return path time of the punching blades 21 is obtained from the encoder 206. The CPU 55 stops the punching blades 21 at the home position HP thereof based on the position detection signal S24 of the punching blades 21, which is outputted from the position sensor 212, and the reverse rotation brake retain time Y.

In this example, the CPU 55 calculates a formula (1) when a period of the time when the punching blades 21 pass through a specific interval during a period of the return path time is made to be X, constants are made to be α and β and the reverse rotation brake force retain time is made to be Y, more specifically, the following formula is calculated:

Y=−αX+β (1)

The “α” is a constant having a relationship in which the smaller X becomes, the larger Y becomes. It is needless to say that the formula (1) for finding out the reverse rotation brake retain time Y is cited only as one example and it is not limited only by a linear equation (function) and it is also allowed to employ a quadratic equation, a cubic equation or the like.

In the above-mentioned ROM 53, there is stored a brake program during a period of the punching blade stop control time, other than the speed control program during the period of return path time of the punching blades. The contents thereof are: a step of detecting whether the punching blades 21 rush into the home position HP thereof; a step of executing the reverse rotation brake control of the motor 22 during a period of predetermined time from a point of time when the punching blades 21 rush into the home position HP thereof, which is detected here; and a step of prolonging the reverse rotation brake control of the motor 22 based on the time monitoring after reaching a predetermined position within the period of predetermined time.

Here, the reverse rotation brake control of the motor 22 based on the time monitoring means the reverse rotation brake control accompanied by a timer 56. For example, the timer 56 is connected to the CPU 55 which sets unit period of monitoring time on the timer 56 at the point of time when it counts a predetermined number of pulses n, within a period of predetermined time of the execution of the reverse rotation brake, showing the speed of the punching blades, activates the timer 56, prolongs the reverse rotation brake control directly, resets the timer 56 when it counts the next pulse n+1 during the count of the timer 56, prolongs the reverse rotation brake control directly and terminates the count of the timer 56 and stops the reverse rotation brake control when it cannot count the next pulse n+j (j=1, •••) during the count of the timer 56.

The CPU 55 controls the brake of the motor 22 during the punching blade stop control based on a brake program read out of the ROM 53. In this example, it is constituted such that it is detected whether the punching blades 21 rush into the home position HP thereof, the reverse rotation brake control of the motor 22 is executed during a period of predetermined time from a point of time when the punching blades 21 rush into the home position HP thereof and the reverse rotation brake control of the motor 22 is prolonged based on the time monitoring after reaching a predetermined position within the period of predetermined time. It should be noted that it is changed over to a short brake after the reverse rotation brake control stops.

Also, the CPU 55 monitors the rotation direction of the motor 22 when executing the reverse rotation brake based on the time monitoring of the motor 22 for the punching blade drive, and stops the reverse rotation brake control at the point of time when it is detected that the rotation direction of this motor 22 is changed.

It should be noted that to the above-mentioned I/O port 52, the solenoid drive unit 121 is connected other than the motor drive unit 120. It is constituted such that the connected solenoid drive unit 121 receives a solenoid drive signal S21 from the CPU 55, and drives the solenoid 211 based on this solenoid drive signal S21 to drive the fence 24 up and down.

In this example, there is generated a counted value showing one time of the reciprocating movement of the punching blades by the position detection signal S24 from the position sensor 212. It becomes possible to detect (discriminate) by the CPU 55 how many sheets of the paper-sheets 3 are punch-processed based on this counted value, and it becomes possible to notify the number of punches to a high-rank or a low-rank control system. Thus, a control system of the punching process unit 20′ is constituted.

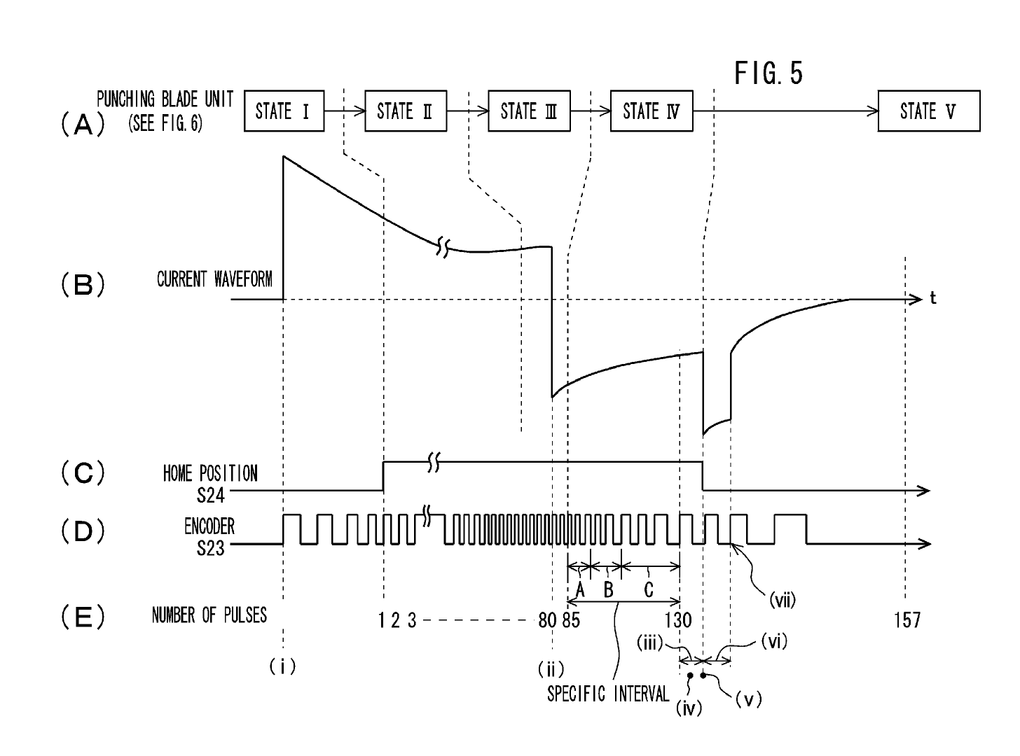

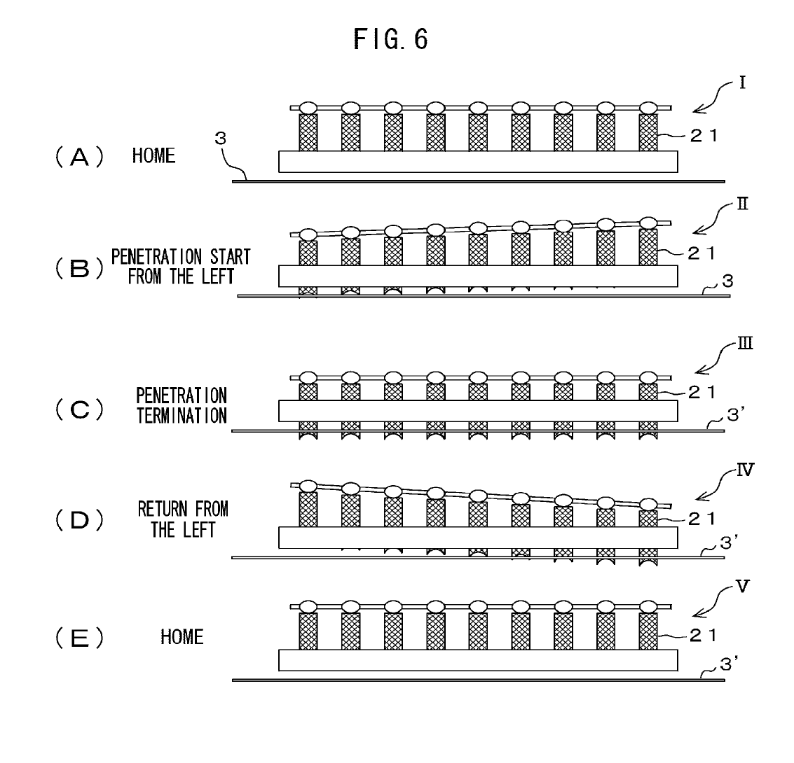

The following will describe state examples of the punching blade unit 202, control examples of the motor 22 and state examples of the punching blades 21 with reference to FIGS. 5(A) to 5(E) and FIGS. 6(A) to 6(E). In this example, a state I shown in FIG. 5(A) is a case in which the punching blade unit 202 is at the home position HP thereof (see FIG. 6(A)).

FIG. 5(B) is a current waveform diagram showing a drive example of the motor 22. In FIG. 5(B), when the motor 22 is started at the position (i), the load (punching blade unit 202) at the start-up time is heavy, so that the waveform rises up rapidly and thereafter, the load becomes light gradually and the waveform falls smoothly. At that time, in a state II shown in FIG. 5(A), the punching blade unit 202 is made to start penetration into the paper-sheets 3 from the left (see FIG. 6(B)).

Thereafter, in a state III, the punching blade unit 202 terminates the penetration into the paper-sheets 3. At that time, the punching blade unit 202 reaches the lowest point (see FIG. 6(C)) thereof. Then, the punching blades 21 enter into a return path thereof. At that time, in a state IV shown in FIG. 5(A), the punching blade unit returns from the left side and is restored to the home position HP thereof (see FIG. 6(D)). Then, the encoder 206 is monitored at the position (ii) and when reaching the number of set pulses Px (0 to 157), the first short brake control is executed with respect to the motor 22. It is constituted in the short brake control such that the motor 22 is cut off from the power supply so as to be short-circuited (shorted) between the terminals thereof, the motor 22 is functioned as a generator, and braking is executed by utilizing an armature reaction thereof.

FIG. 5(C) is a waveform example showing a home position detection example by means of the position sensor 212. The position detection signal S24 shown in FIG. 5(C) is in a case in which the punching blade unit escapes from the home position HP by the high-level thereof (hereinafter, referred to as “H” level). Also, it is in a case in which the punching blade unit stays at the home position HP by the low-level thereof (hereinafter, referred to as “L” level).

FIG. 5(D) is a waveform diagram of a speed detection example by means of the encoder 206. In the drawing, A, B and C show control intervals. The encoder 206 outputs the speed detection signal S23 during the rotation of the motor 22 to the CPU 55. With respect to the speed detection signal S23, the pulse cycle thereof becomes long when the rotation speed of the motor 22 is slow and the pulse cycle thereof becomes short when the rotation speed thereof is fast.

The number of pulses Px shown in FIG. 5(E) is the number of output pulses Px which is reflected to the speed detection signal S23 from the encoder 206 shown in FIG. 4. Table 2 shows a relationship between a specific interval of the number of pulses Px=85 to 130 and the setting values Th1, Th2, Th3 corresponding to the three control intervals A, B and C.

TABLE 2
Specific Interval (Return Path Stroke of Punching Blades)

| | | Number of | | |
|---|---|---|---|---|
| Control Interval | Division | Pulses | | Setting Value |
| A | Interval 1 | 85 | 88 | Setting Value Th1 |
| | Interval 2 | 88 | 91 | [msec] |
| | Interval 3 | 91 | 94 | |
| | Interval 4 | 94 | 97 | |
| | Interval 5 | 97 | 100 | |
| B | Interval 6 | 100 | 103 | Setting Value Th2 |
| | Interval 7 | 103 | 106 | [msec] |
| | Interval 8 | 106 | 109 | |
| | Interval 9 | 109 | 112 | |
| | Interval 10 | 112 | 115 | |
| | Interval 11 | 115 | 118 | |
| | Interval 12 | 118 | 121 | |
| C | Interval 13 | 121 | 124 | Setting Value Th3 |
| | Interval 14 | 124 | 127 | [msec] |
| | Interval 15 | 127 | 130 | |

In this example, the number of pulses Px=85 to 130 showing a specific interval of a return path stroke of the punching blades 21 is divided into 15 intervals. One interval is set for three pulses. The interval #1 is an interval in which the encoder 206 outputs the number of pulses Px=85 to 88. The interval #2 is, similarly, an interval in which it outputs the number of pulses Px=88 to 91. Hereinafter, also with respect to the interval #3 to the interval #15, they become the intervals in which the encoder 206 outputs the number of pulses Px=91 to 130 for every three pulses.

The 15 intervals of a return path stroke of this punching blades 21 are divided further into three control intervals (groups: set-groups) A, B and C, and the setting values Th1, Th2 and Th3 are allotted for every of the respective groups. According to the table 2, the setting value Th1 is set for the interval #1 to the interval #5, the setting value Th2 is set for the interval #6 to the interval #12, the setting value Th3 is set for the interval #13 to the interval #15. Among the setting values of the three groups, a relationship of, for example, Th1<Th2<Th3 is set. This is because the moving speed to the home position of the punching blades 21 is controlled to be slow gradually.

In the CPU 55, the speed detection signal S23 is sampled after the first short brake control is executed. In this example, the number of output pulses Px of the encoder 206 is monitored and a period of the time (passing time Tx) passing through the 15 intervals (intervals #1 to #15) in which the number of set pulses Px=85 to 130 of a specific interval is separated for every three pulses is measured. The passing time Tx is obtained for every interval. The CPU 55 is constituted to compare the passing time Tx=t1, t2, ••• ••: with a period of time (setting value Th1 or the like) which is set for every interval. In a case in which the relationship between the setting value Th1 or the like and the passing time Tx is, for example, Th1>Tx, the short brake control is continued during the next three pulses. In case of Th1<Tx, the motor 22 of the next interval (during three pulses) is driven by being ON-controlled in the CW direction. The speed control is executed by repeating this control until entering into the home position HP.

The CPU 55 executes the motor reverse rotation brake control at the position (v) based on the reverse rotation brake retain time Y which is obtained by being calculated here. A strong braking force is generated at the motor 22 in a period of the retain time of the position (vi). Continuous with this motor reverse rotation brake control, the CPU 55 executes the second short brake control with respect to the motor 22 at the position (vii).

When controlling the motor 22 in this manner, in a case in which the speed during the period of return path time is faster than a reference speed, it becomes possible for the punching blade unit 202 to be stopped at the home position HP by a brake force stronger than a reference brake force and in a case in which the speed during the period of return path time is slower than a reference speed, it becomes possible for the punching blade unit 202 to be stopped at the home position HP by a brake force weaker than a reference brake force. It should be noted that in a state V shown in FIG. 5(A), the punching blade unit 202 is restored to the home position (see FIG. 6(E)). The punching blades 21 is constituted so as to punch holes through the paper-sheets 3 by driving the punching blades 21 in such a wave shape as undulating to the right and left in this manner.

The following will describe a punching blade stroke example of one cycle in the punching blade unit 202 with reference to FIGS. 7(A) to 7(F). The punching blade unit 202 shown in FIG. 7(A) is in a state of standing-by (being positioned) at the home position HP. The punching blade unit 202 shown in FIG. 7(B) is in a state of descending toward the punched surface of the paper-sheet from the home position HP after the motor 22 is turned ON. The punching blade unit 202 shown in FIG. 7(C) is in a state of reaching the lowest point thereof by having penetrated the punched surface of the paper-sheet. When penetrating this punched surface of the paper-sheet, it becomes in a state in which the holes for the binding are perforated at one end of the sheet shaped paper-sheets 3. “MAX” in the drawing indicates the maximum stroke of the punching blade unit 202.

The punching blade unit 202 shown in FIG. 7(D) is in a state of ascending to the home position HP through the punched surface of the paper-sheet by having escaped from the lowest point. During a period of this ascending time, the CPU 55 receives the speed detection signal S23 during the period of return path time of the punching blades, which is detected by the encoder 206, and calculates the reverse rotation brake retain time Y based on this speed detection signal S23.

The punching blade unit 202 shown in FIG. 7(E) is in a state just before the home position detection. At that time, the motor reverse rotation brake control is executed based on the reverse rotation brake retain time Y which has been calculated and found out beforehand. Thus, it is possible for the punching blade unit 202 to be stopped always at the home position HP. The punching blade unit 202 shown in FIG. 7(F) is in a state of being stopped at home position HP and becomes in a state of waiting for the punching process of the next paper-sheets 3.

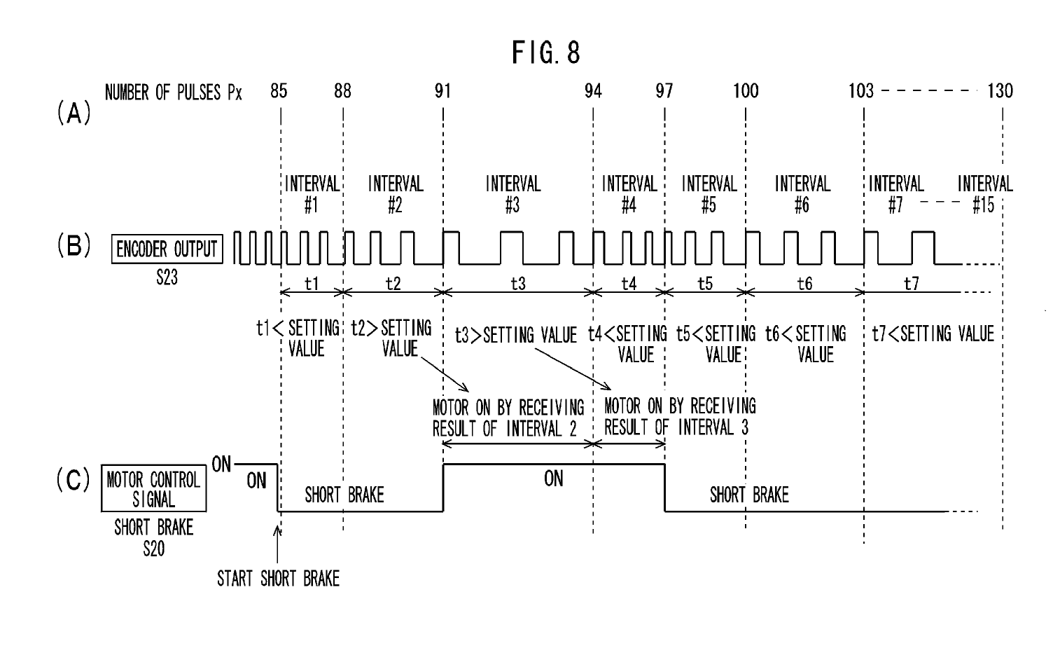

The following will describe a motor control example in a return path stroke (specific interval) of the punching blades 21 with reference to FIGS. 8(A) to 8(C). The number of pulses Px shown in FIG. 8(A) is the number of output pulses Px which is reflected to the speed detection signal S23 from the encoder 206 shown in FIG. 4. In this example, the number of pulses Px=88 separates the intervals #1 and #2. Similarly, the number of pulses Px=91 thereof separates the intervals #2 and #3, the number of pulses Px=94 separates the intervals #3 and #4, the number of pulses Px=97 separates the intervals #4 and #5, the number of pulses Px=100 separates the intervals #5 and #6, the number of pulses Px=103 separates the intervals #6 and #7, and the number of pulses Px=106 separates the intervals #7 and #8.

In the output waveform of the encoder 206 shown in FIG. 8(B), the CPU 55 measures the passing time Tx=t1 in the interval #1. The passing time Tx=t1 is obtained from the pulse widths of the number of pulses Px=[88-85] in the interval. Similarly, the passing time Tx=t2 is measured in the interval #2. The passing time Tx=t2 is obtained from the sum of pulse widths of the number of pulses Px=[91-88]. The passing time Tx=t3 is measured in the interval #3. The passing time Tx=t3 is obtained from the sum of pulse widths of the number of pulses Px=[94-91].

Further, the passing time Tx=t4 is measured in the interval #4. The passing time Tx=t4 is obtained from the sum of pulse widths of the number of pulses Px=[97-94]. The passing time Tx=t5 is measured in the interval #5. The passing time Tx=t5 is obtained from the sum of pulse widths of the number of pulses Px=[100-97]. The passing time Tx=t6 is measured in the interval #6. The passing time Tx=t6 is obtained from the sum of pulse widths of the number of pulses Px=[103-100]. The CPU 55 measures the passing time Tx=tx until reaching the interval #15.

In this example, when the CPU 55 detects the number of pulses Px of 80 of the encoder 206 in the output waveform shown in FIG. 8(C), it outputs the motor control signal S20 to the motor drive unit 120. The motor control signal S20 is a signal falling from a high-level (hereinafter, referred to as “H” level) to a low-level (hereinafter, referred to as “L” level). Thus, a short brake of the motor 22 starts. During a period of the short brake time, the power supply is cut off from the motor 22 so as to be short-circuited between the terminals thereof.

The CPU 55 compares the passing time Tx=t1 measured in the interval #1 shown in FIG. 8(B) with the setting value Th1 which has preset. In a case in which t1<Th1 is obtained from a result of this comparison, it becomes in a state in which the CPU 55 continues the control by maintaining the short brake with respect to the interval #2.

Next, the CPU 55 compares the passing time Tx=t2 with the setting value Th1 in the interval #2. In a case in which t2>Th1 is obtained from a result of this comparison, the motor 22 is ON-controlled in the CW direction in the interval #3 in response to the result of comparison of the interval #2. In this example, when the number of pulses Px of the encoder 206 is 91, the motor control signal S20 uprises from the “L” level to the “H” level. Thus, the motor 22 is ON-controlled in the CW direction and is driven by being applied with a predetermined voltage between the terminals thereof. It should be noted that the electrical time constant and the mechanical time constant exist in the motor 22, so that a period of the rise time is required until reaching the target speed actually from a point of the time when a predetermined voltage is applied to the motor 22 by outputting the motor control signal S20 to the motor drive unit 120.

Further, the CPU 55 compares the passing time Tx=t3 with the setting value Th1 in the interval #3. In a case in which t3>Th1 is obtained from the result of this comparison, the ON-control of the CW direction to the motor 22 is continued in the interval #4 in response to the result of the comparison of the interval #3. In this example, also when the number of pulses Px of the encoder 206 is 94, the motor control signal S20 is maintained to be in the “H” level, and the motor 22 is driven in a condition in which the voltage applied between the terminals thereof is kept without change.

Also, the CPU 55 compares the passing time Tx=t4 with the setting value Th1 in the interval #4. In a case in which t4<Th1 is obtained from the result of this comparison, the short brake control of the motor 22 is executed in the interval #5 in response to the comparison result of the interval #4. In this example, when the number of pulses Px of the encoder 206 is 97, the motor control signal S20 falls from the “H” level to the “L” level. Thus, a short brake of the motor 22 starts. During a period of the short brake time, the power supply is cut off from the motor 22 so as to be short-circuited between the terminals thereof.

Hereinafter, in such a case in which: t5<Th1 is obtained as a result after comparing the passing time Tx=t5 with the setting value Th1 in the interval #5; t6<Th1 is obtained as a result after comparing the passing time Tx=t6 and the setting value Th1 in the interval #6; the passing time Tx=t7 is measured in the interval #7; and ••• •••, when the number of pulses Px of the encoder 206 is 100, 103, ••• •••, the motor control signal S20 is maintained to be in the “L” level and the short brake of the motor 22 is continued.

### Embodiment 1

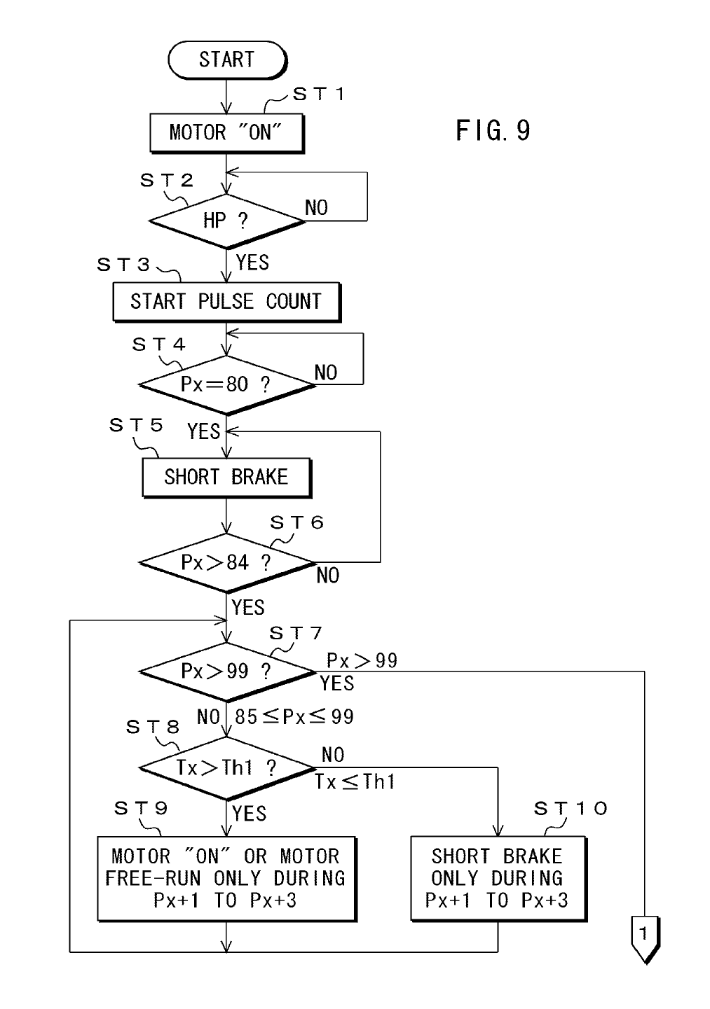

The following will describe control examples (Nos. 1 to 3 thereof) of the punching process unit 20′ relating to a first embodiment with reference to FIG. 9 to FIG. 11. In this embodiment, there is assumed a control in which: the deceleration gear turns fully around one time when the motor 22 rotates based on the motor control signal S20; the cams 82 rotate fully around one time through the cam shaft 81 attached thereto; and the punching blades 21 start from the home position HP, punch the paper-sheets and return to the home position HP again.

The encoder 206 outputs the number of pulses 1 to 157 with respect to the speed detection signal S23. A case is illustrated in which: comparison with the setting value Th1 is executed when the number of pulses Px is 85≦Px≦99; comparison with the setting value Th2 is executed when the number of pulses Px is 100≦Px≦120; and comparison with the setting value Th3 is executed when the number of pulses Px is 121≦Px≦129. It should be noted that when a period of the passing time of the interval is to be Tx, the passing time t1 of the interval #1, the passing time t2 of the interval #2, ••• ••• is substituted for the Tx.

Also, the motor drive unit 120 is in a state of waiting for a start-up command of the motor 22 from the CPU 55. The motor 22 is cut off from the power supply and waits in a short brake state where the terminals thereof are short-circuited. In this example, a punching process command is applied from a high-rank control system to the CPU 55.

By the control condition based on these, the motor drive unit 120 turns ON the motor 22 in step ST1 of the flowchart shown in FIG. 9 when inputting the start-up command of the motor 22 from the CPU 55. At that time, the motor control signal S20 outputted from the CPU 55 to the motor drive unit 120 uprises from the “L” level to the “H” level.

Next, in step ST2, the CPU 55 monitors the home position HP of the punching blades 21. At that time, the position sensor 212 outputs the position detection signal S24 to the CPU 55 when detecting the home position HP thereof. The CPU 55 receives the position detection signal S24 in step ST3 and starts the pulse count. At that time, the encoder 206 outputs the speed detection signal S23 to a counter in the CPU 55. The counter counts (detects) the number of pulses Px=1 to 157 obtained from the encoder 206.

Thereafter, in step ST4, the CPU 55 monitors that the number of pulses Px reaches 80. This monitoring is for finding out a point of time when the punching blades 21 rush into a return path stroke when returning to the home position HP again after punching the paper-sheets 3. When the number of pulses Px reached 80, the punching blades 21 rush into the return path stroke, so that the process shifts to step ST5 where the CPU 55 starts the short brake control and continues the control thereof until the number of pulses Px becomes 84. Then, it is judged in step ST6 whether the number of pulses Px exceeds 84. This is because it finds out whether or not the punching blades 21 rush into the specific interval.

When the number of pulses Px exceeds 84, the process shifts to step ST7 where the CPU 55 judges whether the number of pulses Px exceeds 99. When the number of pulses Px is 85≦Px≦99, the process shifts to step ST8. In the step ST8, the CPU 55 compares the passing time Tx with the setting value Th1 and branches the control.

If the passing time Tx is longer than the setting value Th1, the process shifts to step ST9 where the motor 22 is turned ON in the CW direction only for Px+1 to Px+3 in relation to the number of pulses Px during a period of time when passing through the next interval #(N+1). Alternatively, the motor 22 is made to free-run during that period. The free-run of the motor 22 means that the power supply terminals are opened and the motor 22 is rotated by inertia.

According to the example shown in FIG. 8(B), the CPU 55 compares the passing time Tx=t2 with the setting value Th1 in the interval #2. There is obtained t2>Th1 from the result of this comparison, so that the motor 22 is made to be ON-controlled in the CW direction in the interval #3 in response to the result of the comparison of this interval #2. Thereafter, the process returns to the step ST7.

It should be noted that when the passing time Tx is shorter than the setting value Th1, the process shifts to step ST 10 where the short brake of the motor 22 is continued only for Px+1 to Px+3 in relation to the number of pulses Px during a period of time when passing through the next interval # (N+1). According to the example shown in FIG. 8(B), the CPU 55 compares the passing time Tx=t1 measured in the interval #1 with the setting value Th1 which has been preset. The CPU 55 obtains the t1<Th1 from the result of the comparison, so that it becomes in a state of continuing the control by maintaining the short brake with respect to the interval #2. Thereafter, the process returns to the step ST7.

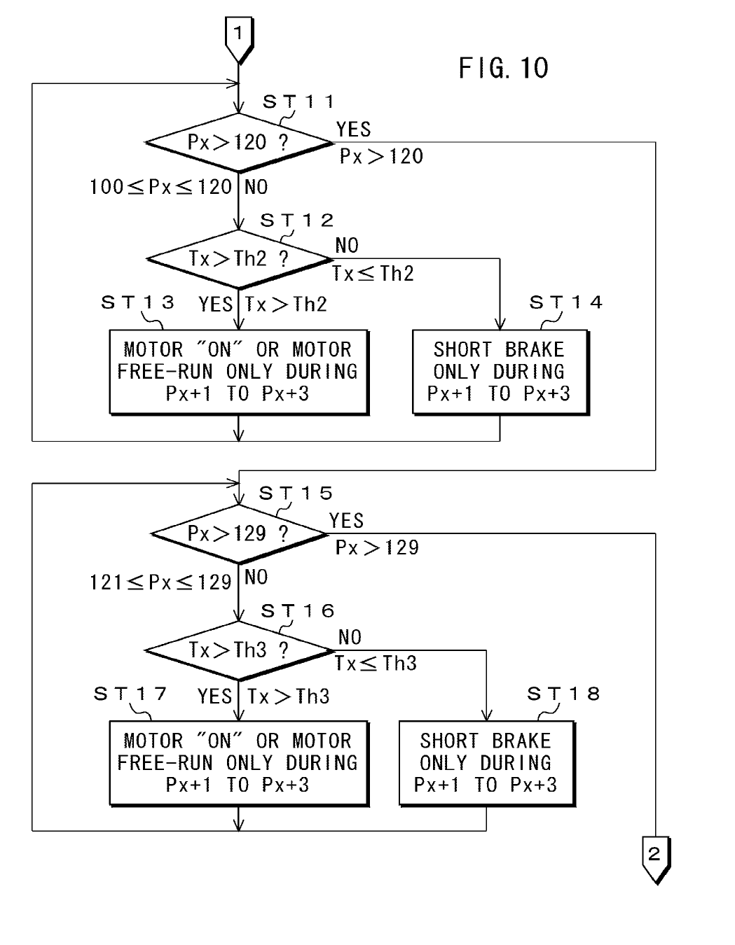

When the number of pulses Px exceeds 99 in the above-mentioned step ST7, the process shifts to step ST11 shown in FIG. 10. In the step ST11, the CPU 55 judges whether the number of pulses Px exceeds 120. When the number of pulses Px is 100≦Px≦120, the process shifts to step ST12. In the step ST12, the CPU 55 compares the passing time Tx with the setting value Th2 and branches the control.

When the passing time Tx is longer than the setting value Th2, the process shifts to step ST 13 where the motor 22 is turned ON in the CW direction only for Px+1 to Px+3 in relation to the number of pulses Px during a period of time when passing through the next interval #(N+1). Alternatively, the motor 22 is made to free-run during that period. At that time, the CPU 55 compares the passing time Tx with the setting value Th2 in the interval #N. In a case in which the Tx>Th2 is obtained from this result of the comparison, the motor 22 is made to be ON-controlled in the CW direction in the interval #(N+1) in response to the result of the comparison of this interval #N. Thereafter, the process returns to the step ST11. Also, when the passing time Tx is shorter than the setting value Th2, the process shifts to step ST 14 where the short brake of the motor 22 is continued only for Px+1 to Px+3 in relation to the number of pulses Px during a period of time when passing through the next interval #(N+1). At that time, the CPU 55 compares the passing time Tx measured in the interval #N with the setting value Th2 which has been preset. When obtaining the Tx<Th2 from the result of comparison, the CPU 55 becomes in a state of continuing the control by maintaining the short brake with respect to the next interval #(N+1). Thereafter, the process returns to the step ST11.

When the number of pulses Px exceeds 120 in the above-mentioned step ST11, the process shifts to step ST15 shown in FIG. 10. In the step ST15, the CPU 55 judges whether the number of pulses Px exceeds 129. When the number of pulses Px is 121≦Px≦129, the process shifts to step ST16. In the step ST16, the CPU 55 compares the passing time Tx with the setting value Th3 and branches the control.

When the passing time Tx is longer than the setting value Th3, the process shifts to step ST 17 where the motor 22 is turned ON in the CW direction only for Px+1 to Px+3 in relation to the number of pulses Px during a period of time when passing through the next interval #(N+1). Alternatively, the motor 22 is made to free-run during that period. At that time, the CPU 55 compares the passing time Tx with the setting value Th3 in the interval #N. In a case in which the Tx>Th3 is obtained from the result of this comparison, the motor 22 is made to be ON-controlled in the interval # (N+1) in response to the result of the comparison of this interval #N. Thereafter, the process returns to the step ST15.

Also, when the passing time Tx is shorter than the setting value Th3, the process shifts to step ST 18 where the short brake of the motor 22 is continued only for Px+1 to Px+3 in relation to the number of pulses Px during a period of time when passing through the next interval #(N+1). At that time, the CPU 55 compares the passing time Tx measured in the interval #N with the setting value Th3 which has been preset. When obtaining Tx<Th3 from the result of the comparison, the CPU 55 becomes in a state of continuing the control by maintaining the short brake with respect to the next interval #(N+1). Thereafter, the process returns to the step ST15.

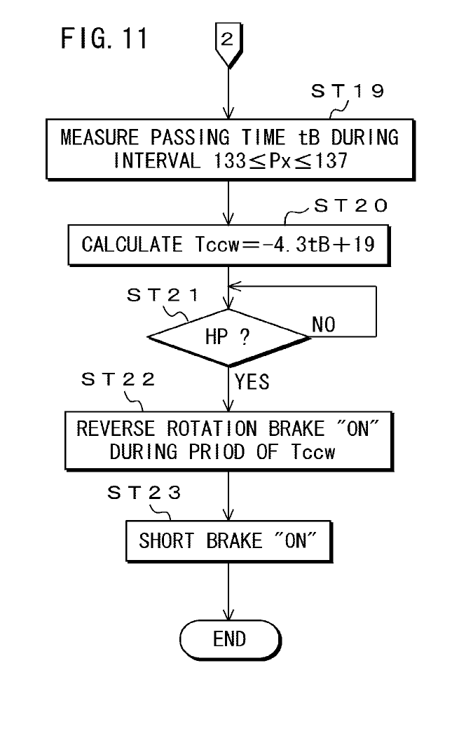

When the number of pulses Px exceeds 129 in the above-mentioned step ST15, the process shifts to step ST19 shown in FIG. 11 by maintaining a state of step ST16 or step ST17 up to Px=132. In the step ST19, the CPU 55 measures a period of the passing time Tx=tB of the interval of 133≦Px≦137 with respect to the number of pulses Px based on the speed detection signal S23. It should be noted in the interval thereof that the short brake state is maintained for the motor 22.

Then, in step ST20, the CPU 55 calculates the reverse rotation brake retain time Y=TCCW by substituting the passing time Tx=tB for X of the formula (1), by substituting 4.3 for the constant a and by substituting 19 for β respectively. More specifically, the formula (1) mentioned above is rewritten as a formula (1)′.

TCCW=−4.3 tB+19 (1)′

However, α=4.3 and β=19 are experimental values and are values when the present inventors performed experimentations and the most suitable reverse rotation brake retain time TCCW was obtained. The CPU 55 becomes in a state of calculating the reverse rotation brake retain time TCCW by utilizing the above-mentioned formula (1)′ at the position (iv) of the current waveform shown in FIG. 5(B). The TCCW is a period of time when the speed of the punching blades 21 becomes zero.

Thereafter, in step ST21, the CPU 55 monitors the home position HP of the punching blades 21. At that time, when the punching blades 21 rush into (IN) the home position, the position sensor 212 outputs the position detection signal S24 to the CPU 55. In step ST22, the CPU 55 receives the position detection signal S24 and executes the reverse rotation brake only for the reverse rotation brake retain time Tx=TCCW [msec] at the position (v) shown in FIG. 5(B). At that time, a strong braking force is generated at the motor 22 in a period of the retain time of the position (vi) of the same drawing.

After the termination of the reverse rotation brake, the CPU 55 executes the short brake control in step ST23. At that time, at the position (vii) shown in FIG. 5(B), the CPU 55 executes the short brake control through the motor drive unit 120 with respect to the motor 22 in succession with the reverse rotation brake control of the motor 22. Thus, the speed control of the motor 22 is terminated.

In this manner, according to the binding device 100 to which the paper-sheet punching device as the first embodiment is applied and the control method thereof, when holes are punched through a predetermined paper-sheets 3, it is constituted such that the control unit 50: sets the intervals #1 to #15 by separating a specific interval during the period of return path time of the punching blades into 15 intervals; as shown in the table 2, sets the setting value Th1 to the intervals #1 to #5 of the group A; sets the setting value Th2 to the intervals #6 to #12 of the group B; sets the setting value Th3 to the intervals #13 to #15 of the group C; measures the period of the actual passing time Tx of the punching blades 21 for each of the intervals #1 to #15; compares the setting values Th1, Th2, Th3 which are set for every group or the like and the passing time Tx=tx obtained by the actual measurement; and controls a drive or a brake of the motor 22 for the punching blade drive in the next interval #(N+1) based on a result of that comparison.

Consequently, the speed control during a period of return path time of the punching blades 21 can be executed with high definition and also with high resolution, so that it becomes possible to avoid a situation in which the punching blades 21 are stopped before the home position HP thereof or the punching blades 21 stop beyond the home position HP thereof. Thus, even if the paper-sheets 3 are thick or they are thin, it is possible for the punching blades 21 after the punch to stop at the home position HP thereof with excellent repeatability. Consequently, it is possible for the punching blades 21 to be reciprocatingly moved by always making the home position HP as a reference.

Although, in the above-mentioned embodiment, a case in which the number of set pulses Px=85 to 130 of a specific interval is separated for every three pulses, it is not limited to this; it is also allowed to execute the speed control of the motor 22 by separating these for every one pulse. It becomes possible to execute the speed control further highly accurately.

### Embodiment 2

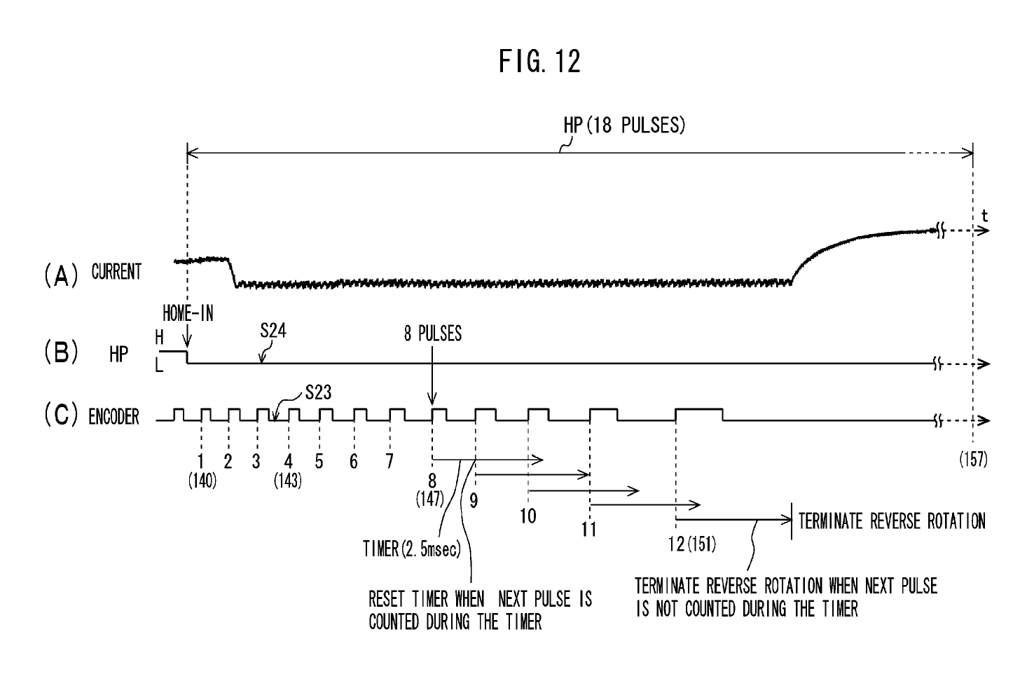

The following will describe a reverse rotation brake control example during a period of the stop time of the punching blades as a second embodiment with reference to FIGS. 12(A) to 12(C). FIGS. 12(A) to 12(C) are magnified examples of the position (vi) between the state IV and the state V which are shown in FIGS. 5(A) to 5(E).

In this embodiment, the home position HP is to be set in the interval in which the encoder 206 counts the number of pulses Px by 18 pulses of the speed detection signal S23 after detecting the home-in of the punching blade unit 202 (punching blades 21). For example, when the position sensor 212 detects the home-in of the punching blades 21 and if the number of pulses Px of the encoder 206 is 140, the home position HP becomes 18 pulses from 140 to 157.

It should be noted that the predetermined number of pulses is set to 8 pulses in order to start the prolongation of the reverse rotation brake control. This is an intermediate position of the home position HP and is a portion in which the number of pulses Px of the encoder 206 becomes in the vicinity of 147. With respect to the period of unit monitoring time, 2.5 ms is set on the timer 56. This is because it is a suitable value for the encoder 206 to detect one pulse (passing time) from the rising-up of the motor 22.

In this embodiment, when the position sensor 212 shown in FIG. 4 detects the home-in of the punching blade unit 202 (punching blades 21), there is started the reverse rotation brake control during a period of the stop time of the punching blades in succession with the speed control during the period of return path time of the punching blades 21. At that time, the CPU 55 discriminates that the punching blades 21 attain the home-in depending on a fact that the position detection signal S24 shown in FIG. 12(B) falls from the “H” level to the “L” level.

The CPU 55 executes the motor reverse rotation brake control at the position (v) based on the reverse rotation brake retain time Y obtained by calculating in FIG. 5(D) before the punching blades 21 attain the home-in. Thus, a strong braking force is generated at the motor 22 in the period of retain time of the position (vi). In succession with this motor reverse rotation brake control, there is executed the reverse rotation brake control including prolongation during the period of stop time of the punching blades. In FIG. 12(A), there is shown a current waveform example of the motor 22 by means of the reverse rotation brake control including prolongation during the period of stop time of the punching blades.

According to the reverse rotation brake control example shown in FIG. 12(A), when the number of pulses of the speed detection signal S23 is counted after the home-in of the punching blades 21 and a predetermined number of pulses is counted within the reverse rotation brake retain time (TCCW), it is changed over, at that point of time, to the reverse rotation brake control accompanied by the timer 56 of the unit monitoring time. For example, at the point of time when the 8th pulse of the speed detection signal S23 after the home-in of the punching blades 21 is counted, the CPU 55 sets the period of unit monitoring time to 2.5 ms on the timer 56, starts up the timer 56 and concurrently, prolongs the reverse rotation brake control without change. Further, if the next 9th pulse is counted during the count of the timer 56, the CPU 55 resets the timer 56 and concurrently, prolongs the reverse rotation brake control without change. Similarly, if the next pulse is counted during the count of the timer 56, the CPU 55 resets the timer 56 and concurrently, prolongs the reverse rotation brake control without change.

In this embodiment, there is shown a case in which the next 13th pulse is not counted during a count of the timer 56. In this case, the CPU 55 terminates the count of the timer 56 and concurrently terminates the reverse rotation brake control. Thereafter, at the position (vii) shown in FIG. 5(D), the CPU 55 executes the short brake control of the motor 22. When the motor 22 is controlled in this manner, in a case in which the speed of the punching blade unit 202 is faster than the reference speed during the period of stop time of the punching blades, it is possible to prolong the reverse rotation brake control without change based on the period of unit monitoring time=2.5 ms and it becomes possible for the punching blades 21 to stop in the home position HP thereof without making the punching blades 21 overrun.

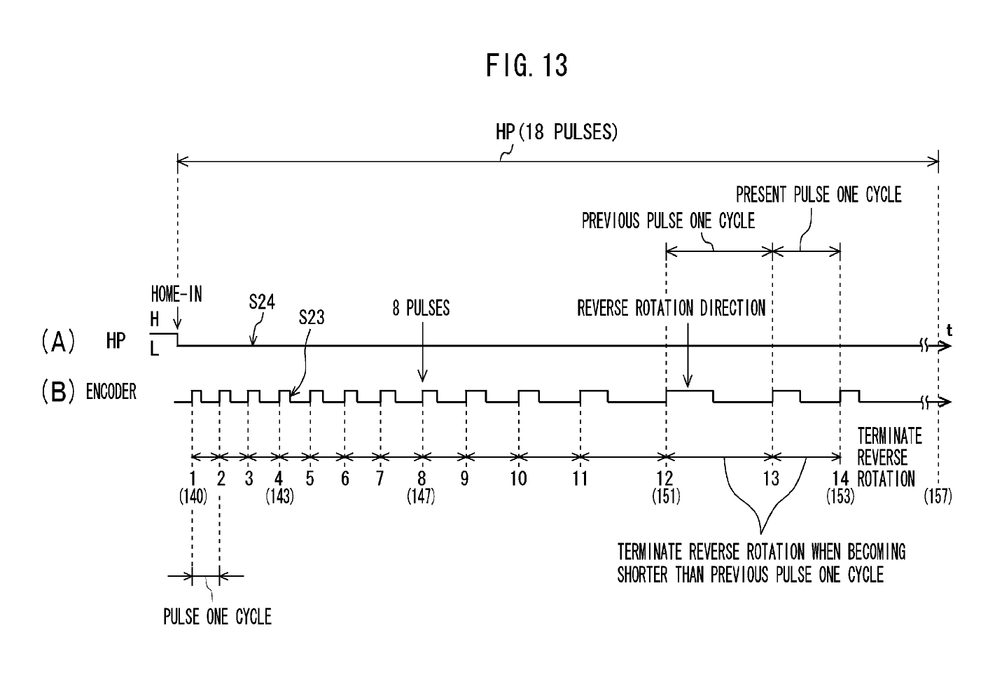

The following will describe a reversal detection example during the period of stop time of the punching blades with reference to FIGS. 13(A) and 13(B). In this example, it is constituted such that the rotation direction of the motor 22 is monitored during the execution of the reverse rotation brake control based on the time monitoring of the motor 22 for the punching blade drive and the reverse rotation brake control is stopped at the point of time when it is detected that the rotation direction of this motor 22 is changed.

In this example, the previous pulse interval (pulse one cycle) and the present pulse interval (pulse one cycle) are compared. For example, when the position sensor 212 shown in FIG. 4 detects the home-in of the punching blades 21 and the position detection signal S24 shown in FIG. 13(A) falls from the “H” level to the “L” level, the CPU 55 measures the pulse one cycle (pulse interval) of the speed detection signal S23, as shown in FIG. 13(B), which is detected subsequently, compares the large-small size relationship of the consecutive previous and present pulse one cycles, and executes the reversal detection of the motor 22.

For example, when one cycle of the present pulse is longer than that of the previous pulse, the CPU 55 judges that the motor 22 keeps the positive rotation thereof. When one cycle of the present pulse becomes shorter than that of the previous pulse, the CPU 55 judges that the motor 22 is changed over to the reverse rotation by reversing the rotation direction. More specifically, when the pulse interval becomes shorter than the just previous pulse interval, the rotation direction is changed and it is changed over to a state of accelerating. In the example shown in FIG. 13(B), there is shown a case in which at the timing of the 12th pulse of the encoder output, the motor 22 is reversed in the rotation direction from the positive rotation and changed over to the reverse rotation. When the reversal of such a rotation direction is detected, it is constituted such that the reverse rotation brake control is terminated and the control is changed over from the reverse rotation brake to a short brake.

Thus, in the encoder output (speed detection signal S23) shown in FIG. 12(C), even in a case in which the period of unit monitoring time is set on the timer 56 and the reverse rotation brake control is prolonged, it becomes possible to prevent a situation in which the rotation direction of the motor 22 is reversed from the positive rotation and the acceleration is kept continuously in the reverse rotation.

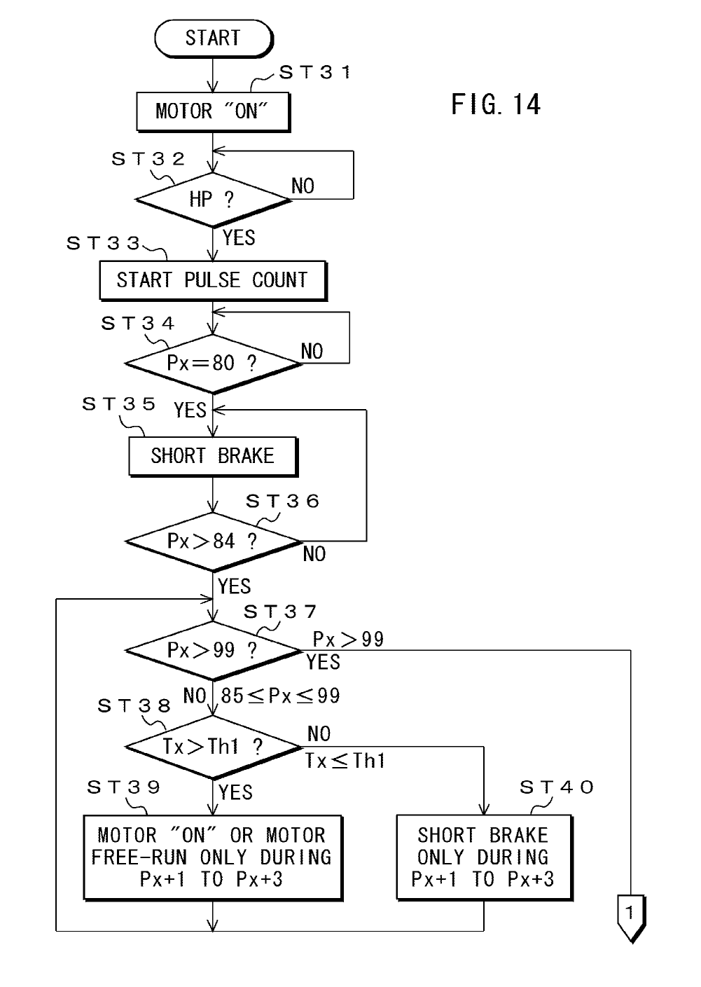

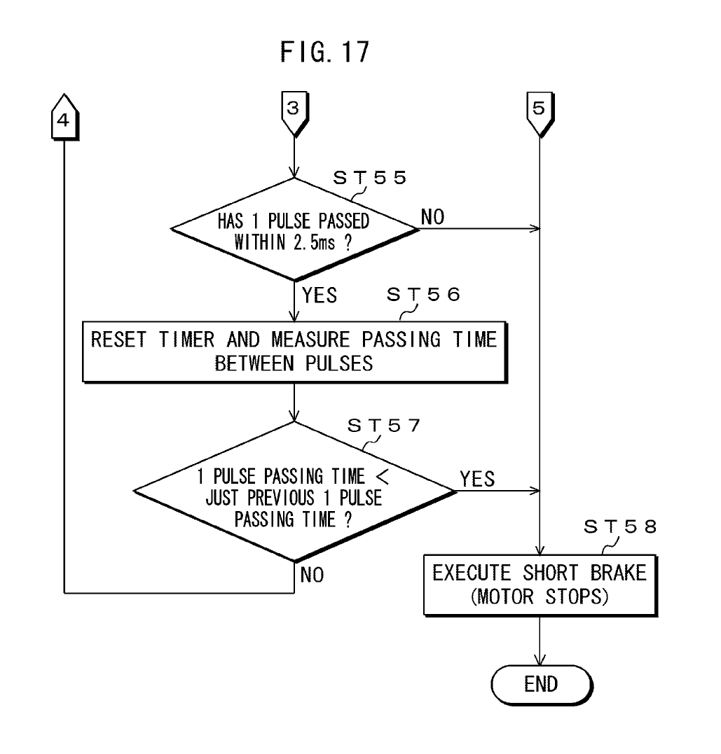

The following will describe control examples (Nos. 1 to 4 thereof) of the punching process unit 20′ with reference to FIG. 14 to FIG. 17. In this embodiment, there is assumed a case in which the motor 22 for the punching blade drive is driven and the punching blades are reciprocatingly moved when two or more holes are punched at one end of the paper-sheets 3. For example, when the motor 22 rotates based on the motor control signal S20, the deceleration gear turns fully around, so that the cams 82 rotate fully around one time through the cam shaft 81 attached thereto and the punching blades 21 start from the home position HP, punches the paper-sheets and returns to the home position HP again. The encoder 206 outputs the number of pulses 1 to 157 with respect to the speed detection signal S23. In this embodiment, there is cited a case in which a shift to the punching blade stop control is performed after detecting the home-in of the punching blades 21. In this embodiment, the process contents relating to those from step ST31 to step ST48 are similar as the process contents from step ST1 to step ST18 which have been explained in the first embodiment.

By the control condition based on these, the motor drive unit 120 turns ON the motor 22 in step ST31 of the flowchart shown in FIG. 14 when inputting a start-up command of the motor 22 from the CPU 55. At that time, the motor control signal S20 outputted from the CPU 55 to the motor drive unit 120 uprises from the “L” level to the “H” level.

Next, in step ST32, the CPU 55 monitors the home position HP of the punching blades 21. At that time, the position sensor 212 outputs the position detection signal S24 to the CPU 55 when detecting the home position HP thereof. The CPU 55 receives the position detection signal S24 in step ST33 and starts the pulse count. At that time, the encoder 206 outputs the speed detection signal S23 to a counter in the CPU 55. The counter counts the number of pulses Px =1 to 157 obtained from the encoder 206.

Thereafter, in step ST34, the CPU 55 monitors that the number of pulses Px reaches 80. This monitoring is for finding out a point of time when the punching blades 21 rush into a return path stroke when returning to the home position HP again after punching the paper-sheets 3. When the number of pulses Px reached 80, the punching blades 21 rush into the return path stroke, so that the process shifts to step ST35 where the CPU 55 starts the short brake control and continues the control thereof until the number of pulses Px becomes 84. Then, it is judged in step ST36 whether the number of pulses Px exceeds 84. This is because it finds out whether the punching blades 21 rush into a specific interval.

When the number of pulses Px exceeds 84, the process shifts to step ST37 where the CPU 55 judges whether the number of pulses Px exceeds 99. When the number of pulses Px is 85≦Px≦99, the process shifts to step ST38. In the step ST38, the CPU 55 compares the passing time Tx with the setting value Th1 and branches the control.

If the passing time Tx is longer than the setting value Th1, the process shifts to step ST39 where the motor 22 is turned on in the CW direction only for Px+1 to Px+3 in relation to the number of pulses Px during a period of time when passing through the next interval #(N+1). Alternatively, the motor 22 is made to free-run during that period. The free-run of the motor 22 means that the power supply terminals are opened and the motor 22 is rotated by inertia. According to the example shown in FIG. 8(B), the CPU 55 compares the passing time Tx=t2 with the setting value Th1 in the interval #2. There is obtained t2>Th1 from the result of this comparison, so that the motor 22 is made to be ON-controlled in the CW direction in the interval #3 in response to the result of the comparison of this interval #2. Thereafter, the process returns to the step ST37.

It should be noted that when the passing time Tx is shorter than the setting value Th1, the process shifts to step ST 40 where the short brake of the motor 22 is continued only for Px+1 to Px+3 in relation to the number of pulses Px during a period of time when passing through the next interval # (N+1). According to the example shown in FIG. 8(B), the CPU 55 compares the passing time Tx=t1 measured in the interval #1 with the setting value Th1 which has been preset. The CPU 55 obtains the t1<Th1 from the result of the comparison, so that it becomes in a state of continuing the control by maintaining the short brake with respect to the interval #2. Thereafter, the process returns to the step ST37.

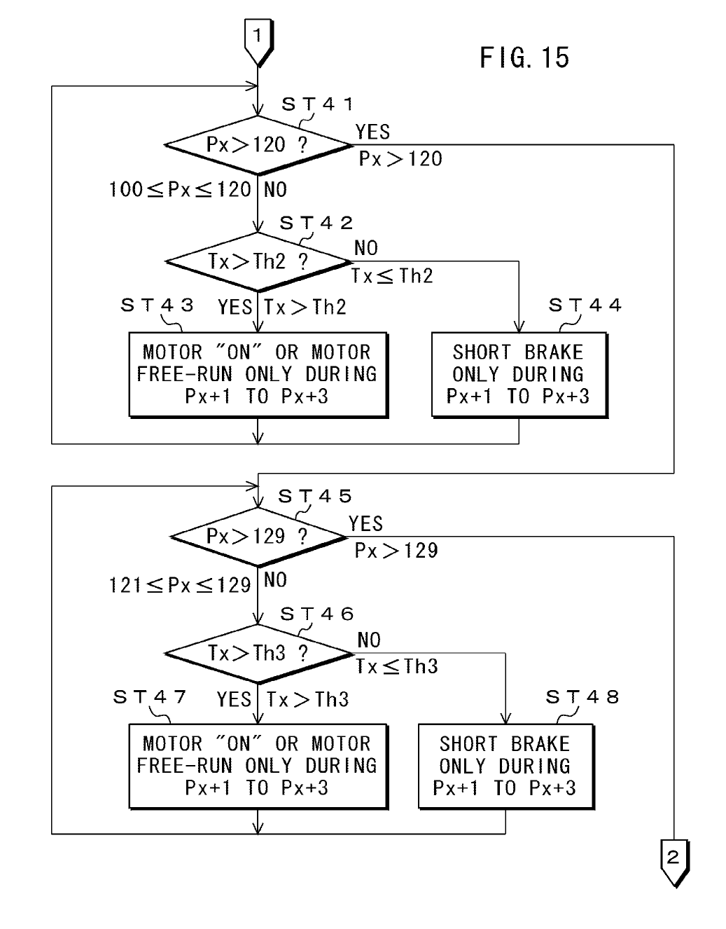

When the number of pulses Px exceeds 99 in the above-mentioned step ST37, the process shifts to step ST41 shown in FIG. 15. In the step ST41, the CPU 55 judges whether the number of pulses Px exceeds 120. When the number of pulses Px is 100≦Px≦120, the process shifts to step ST42. In the step ST42, the CPU 55 compares the passing time Tx with the setting value Th2 and branches the control.

When the passing time Tx is longer than the setting value Th2, the process shifts to step ST43 where the motor 22 is turned ON in the CW direction only for Px+1 to Px+3 in relation to the number of pulses Px during a period of time when passing through the next interval #(N+1). Alternatively, the motor 22 is made to free-run during that period. At that time, the CPU 55 compares the passing time Tx with the setting value Th2 in the interval #N. In a case in which the Tx>Th2 is obtained from this result of the comparison, the motor 22 is made to be ON-controlled in the CW direction in the interval #(N+1) in response to the result of the comparison of this interval #N. Thereafter, the process returns to the step ST41. Also, when the passing time Tx is shorter than the setting value Th2, the process shifts to step ST44 where the short brake of the motor 22 is continued only for Px+1 to Px+3 in relation to the number of pulses Px during a period of time when passing through the next interval #(N+1). At that time, the CPU 55 compares the passing time Tx measured in the interval #N with the setting value Th2 which has been preset. When obtaining the Tx<Th2 from the result of the comparison, the CPU 55 becomes in a state of continuing the control by maintaining the short brake with respect to the next interval #(N+1). Thereafter, the process returns to the step ST41.

When the number of pulses Px exceeds 120 in the above-mentioned step ST41, the process shifts to step ST45 shown in FIG. 15. In the step ST45, the CPU 55 judges whether the number of pulses Px exceeds 129. When the number of pulses Px is 121≦Px≦129, the process shifts to step ST46. In the step ST46, the CPU 55 compares the passing time Tx with the setting value Th3 and branches the control.

When the passing time Tx is longer than the setting value Th3, the process shifts to step ST47 where the motor 22 is turned ON in the CW direction only for Px+1 to Px+3 in relation to the number of pulses Px during a period of time when passing through the next interval #(N+1). Alternatively, the motor 22 is made to free-run during that period. At that time, the CPU 55 compares the passing time Tx with the setting value Th3 in the interval #N. In a case in which the Tx>Th3 is obtained from the result of this comparison, the motor 22 is made to be ON-controlled in the interval # (N+1) in response to the result of the comparison of this interval #N. Thereafter, the process returns to the step ST45.

Also, when the passing time Tx is shorter than the setting value Th3, the process shifts to step ST48 where the short brake of the motor 22 is continued only for Px+1 to Px+3 in relation to the number of pulses Px during a period of time when passing through the next interval #(N+1). At that time, the CPU 55 compares the passing time Tx measured in the interval #N with the setting value Th3 which has been preset. When obtaining the Tx<Th3 from the result of the comparison, the CPU 55 becomes in a state of continuing the control by maintaining the short brake with respect to the next interval #(N+1). Thereafter, the process returns to the step ST45.

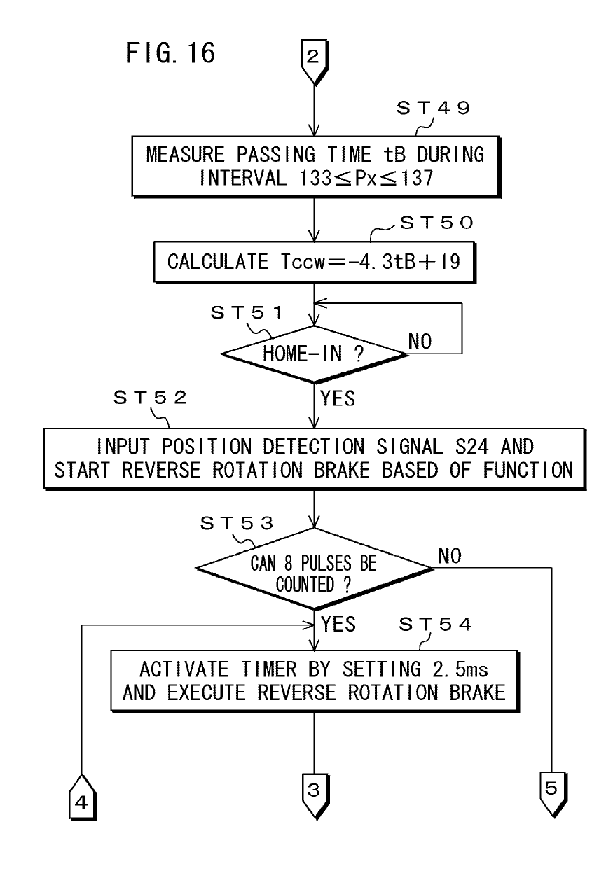

When the number of pulses Px exceeds 129 in the above-mentioned step ST45, the process shifts to step ST49 shown in FIG. 16 by maintaining a state of step ST46 or step ST47 up to Px=132. In the step ST49, the CPU 55 measures a period of the passing time Tx=tB of the interval of 133≦Px≦137 with respect to the number of pulses Px based on the speed detection signal S23. It should be noted in the interval thereof that the short brake state is maintained for the motor 22.

Then, in step ST50, the CPU 55 calculates the reverse rotation brake retain time Y=TCCW by substituting the passing time Tx=tB for X of the formula (1), by substituting 4.3 for the constant a and by substituting 19 for β respectively. More specifically, the formula (1) mentioned above is rewritten as a formula (1)′.

TCCW=−4.3 tB+19 (1)′

However, α=4.3 and β=19 are experimental values and are values when the present inventors performed experimentations and the most suitable reverse rotation brake retain time TCCW was obtained. The CPU 55 becomes in a state of calculating the reverse rotation brake retain time TCCW by utilizing the above-mentioned formula (1)′ at the position (iv) shown in FIG. 5(B). The TCCW is a period of time when the speed of the punching blades 21 becomes zero.

Thereafter, in step ST51, the CPU 55 discriminates whether the punching blades 21 attain the home-in. At that time, when the punching blades 21 rush into (IN) the home position HP, the position detection signal S24 showing that they rush into (IN) the home position HP is outputted from the position sensor 212 to the CPU 55.

Then, the CPU 55 inputs the position detection signal S24 in step ST52 and starts the reverse rotation brake based on a function (reverse rotation brake retain time Tx=TCCW [msec]) shown in (1)′ at the position (v) shown in FIG. 5(B). At that time, a strong braking force generates at the motor 22 in the period of retain time of the position (vi) of the same drawing.

Next, in step ST53, the counter, not shown, in the CPU 55 executes counts of 8 pulses in the reverse rotation brake retain time TCCW. When based on this result, 8 pulses are not counted in the reverse rotation brake retain time TCCW, the process shifts to step ST58 where the CPU 55 controls the motor 22 so as to change over from the reverse rotation brake to the short brake through the motor drive unit 120. Depending on this control, the punching blades 21 received the short brake control stop, so that the speed control of the motor 22 is terminated.

When 8 pulses are counted within the reverse rotation brake retain time TCCW mentioned above, the process shifts to step ST54 where a period of the unit monitoring time of 2.5 ms is set on the timer 56 from the point of time when 8 pulses count is ended, the timer 56 is started up, and the reverse rotation brake control starts.

Thereafter, the process shifts to step ST55 where the CPU 55 judges whether or not one pulse of the speed detection signal S23 is detected (passed through) within the period of unit monitoring time of 2.5 ms. If one pulse of the speed detection signal S23 is not detected within the period of unit monitoring time of 2.5 ms, the process shifts to step ST58 where the CPU 55 controls the motor 22 so as to change over from the reverse rotation brake to the short brake through the motor drive unit 120. Depending on this control, the punching blades 21 received the short brake control stop, so that the CPU 55 terminates the speed control of the motor 22.

When, in the above-mentioned step ST55, one pulse by the speed detection signal S23 is detected within the period of unit monitoring time of 2.5 ms, the process shifts to step ST56 where the timer 56 is reset, the period of unit monitoring time of 2.5 ms is set again on the timer 56, the timer 56 is started up and the reverse rotation brake control is prolonged. At the same time, the pulse one cycle (one pulse passing time) of the speed detection signal S23 after the timer start-up is measured.

Then, in step ST57, the large-small relationship is discriminated depending on the comparison between the pulse one cycle (present one pulse passing time) by the present speed detection signal S23 and the pulse one cycle (preceding one pulse passing time) by the just previous speed detection signal S23. When it is in a case in which the relationship between the present pulse one cycle and the just previous pulse one cycle becomes “present pulse one cycle”>“just previous pulse one cycle”, the process returns to the step ST4 and the processes mentioned above are repeated.

Also, when it becomes “present pulse one cycle”<“just previous pulse one cycle”, the process shifts to step ST58 where the CPU 55 controls the motor 22 so as to change over from the reverse rotation brake to a short brake through the motor drive unit 120. Depending on this control, the punching blades 21 received the short brake control stop. The motor 22 is cut off from the power supply and waits in a state in which the short brake is short-circuited between the terminals thereof. The CPU 55 terminates the speed control of the motor 22 and waits for a next start-up command. In this example, a punching process command is applied from a high-rank control system to the CPU 55.

In this manner, according to the binding device 100 to which the paper-sheet punching device as the second inventive example is applied and the control method thereof, when punching holes through predetermined paper-sheets 3, it is constituted such that the CPU 55 detects whether the punching blades 21 rush into the home position HP thereof, executes the reverse rotation brake control of the motor 22 for the punching blade drive until 8 pulses pass through from a point of time when the punching blades 21 rush into the home position HP thereof, sets the period of unit monitoring time of 2.5 ms after 8 pulses passed through, and prolongs the reverse rotation brake control of the motor 22 until it becomes in a state in which a pulse is not detected within the period of unit monitoring time.

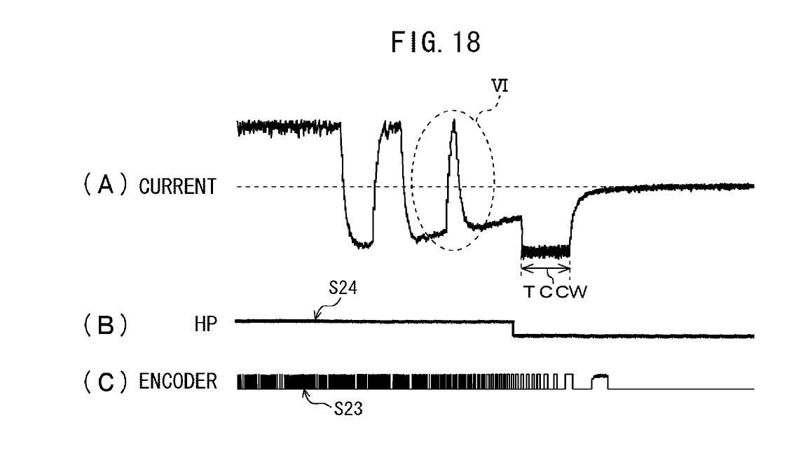

The following will describe a usual operation example of the reverse rotation brake during a period of stop time of the punching blades and a comparison example of the existence or nonexistence of the prolongation of the reverse rotation brake thereof with reference to FIGS. 18(A) to 18(C). According to the usual operation example of the reverse rotation brake during the period of the stop time of the punching blades shown in FIG. 18(A), there is shown a case in which the punching blades 21 can be stopped in the home position HP thereof with the right amounts of the reverse rotation brake by executing the reverse rotation brake control only for the reverse rotation brake retain time TCCW which is determined depending on the speed just before the home position after the home-in shown in FIG. 18(B) is detected. The pulses of the encoder output shown in FIG. 18(C) stop depending on the stop of the punching blades 21.

In this case, in response to a situation of the thickness of the paper-sheets, the ambient temperature, the continuous punch operation and the like, positive rotation correction (state VI shown by a dotted-line ellipse in the drawing) is added in the current waveform shown in FIG. 18A in a return path of the punching blades 21, and the speed control which accelerates the moving speed of the punching blades 21 is executed. Consequently, in a case in which the paper-sheets are thick or the like, even if it happens that the moving speed of the punching blades 21 becomes slow as compared with that of the usual operation time, it becomes possible to repress occurrence of the short-run by the speed control by means of this positive rotation correction. This is because the brake characteristic under the low temperature environment becomes excellent as compared with that under the usual operation environment.

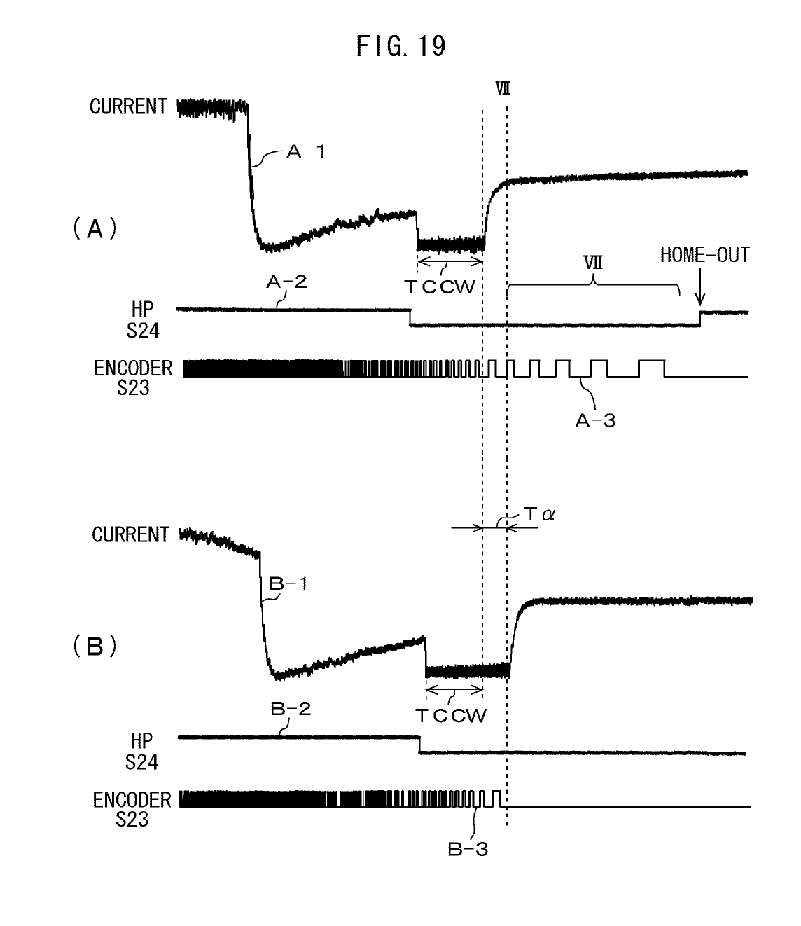

On the other hand, FIGS. 19(A) and 19(B) are operation time charts showing comparison examples of the existence and nonexistence of the prolongation of the reverse rotation brake during the period of stop time of the punching blades. According to an operation example of the nonexistence of the prolongation of the reverse rotation brake during the period of stop time of the punching blades shown in FIG. 19(A), there is shown a case in which the reverse rotation brake control is executed only for the reverse rotation brake retain time TCCW which is determined depending on the speed just before the home position after the home-in is detected by the HP waveform (A-2) shown in FIG. 19(A) without executing the positive rotation correction as shown in FIG. 18(A). In this case, it is an example in which the reverse rotation brake retain time TCCW becomes insufficient and the punching blades 21 overrun without stopping in the home position HP. This is that the brake performance is degraded when the motor 22 becomes in a high temperature depending on the continuous punch operation or the like, so that after the termination of the reverse rotation brake shown in the current waveform (A-1) of FIG. 19(A), it happens that the punching blades 21 do not stop in the home position HP thereof and runs as many as a few pulses of the encoder output (A-3) of FIG. 19(A) (state VII in the drawing). According to this state VII, it is only the reverse rotation brake retain time TCCW which is determined depending on the speed just before the home position, so that the TCCW becomes insufficient and as a result thereof, the punching blades 21 do not stop in the home position HP thereof and the overrun occurs. In the HP waveform (A-2) of FIG. 19(A), a downward arrow is a portion in which the punching blades 21 undergo the home-out.

According to an operation example of the existence of the prolongation of the reverse rotation brake control during the period of stop time of the punching blades shown in FIG. 19(B), the home-in is detected by the HP waveform (B-2) shown in FIG. 19(B) without executing the positive rotation correction as shown in FIG. 18(A). Thereafter, the reverse rotation brake control is executed depending only on the reverse rotation brake retain time TCCW which is determined by the speed just before the home position, and the reverse rotation brake control of the motor 22 for the punching blade drive is executed until 8 pulses passes through from a point of time when the punching blades 21 rush into the home position HP thereof. Further, there is shown a case in which after 8 pulses passed through, the period of unit monitoring time of 2.5 ms is set on the timer 56 and the reverse rotation brake control of the motor 22 is prolonged until it becomes in a state in which a pulse is not detected within this period of unit monitoring time. More specifically, in the punch stop control, it is the time when the timer control is functioned. In the drawing, Tα is the reverse rotation brake time which is prolonged by the punch stop control (timer control) relating to the present invention.

Here, when comparing the reverse rotation brake control shown in FIG. 19(A) with the reverse rotation brake extension control shown in FIG. 19(B), it is understood that the reverse rotation brake time Ta is prolonged by the timer control. In a case in which the time monitoring control of such a timer 56 is functioned, it becomes possible to prevent the motor 22 of the punching process unit 20′ from being rotated too much by prolonging the reverse rotation brake control until the moving speed of the punching blades 21 decelerates sufficiently. Consequently, it is possible to eliminate a phenomenon in which the punching blades 21 could not stop in the home position HP and overruns after the termination of the reverse rotation brake shown in FIG. 19(A).

Thus, it is possible to stop the punching blade in the home position HP efficiently. Consequently, it becomes possible to realize the reciprocating operation by making the home position HP as the reference against the environment change of in a case in which the thickness of the paper-sheets is thin and in a case in which the thickness thereof is thick or the like, and against a case in which the brake performance changes. Also, it becomes possible to provide the highly accurate and also highly reliable paper-sheet punching device 100.

It should be noted, with respect to the time monitoring control of the timer 56, although a case in which the timer 56 is connected to the outside of the CPU 55 has been described, it is not limited to this: it may utilize a timer installed within the CPU 55. The same effect is obtained.

### INDUSTRIAL APPLICABILITY

The present invention is very preferable for being applied to a binding device for binding-processing recording papers outputted from a copy machine and a print device for black-and-white use and for color use.

I/we claim:

1. A paper-sheet punching device that punches a hole through a predetermined paper-sheet, the paper-sheet punching device comprising:
punching unit including a motor for driving a reciprocatingly movable punching blade, having a home position of the punching blade and punching two or more holes at one end of said paper-sheet; and
control unit for controlling said punching unit, wherein said control unit is configured to:
set divisional control intervals by separating a specific interval during a period of return path time of the punching blade into a plurality of intervals,
set a period of target passing time of the punching blade for each of said divisional control intervals or for every set-group of the divisional control intervals so that the period of target passing time of the punching blade has a relationship such that the period of target passing time thereof corresponding to the specific interval which is close to the home position of the punching blade is longer than the period of target passing time thereof corresponding to the specific interval which is away from the home position of the punching blade,
measure a period of actual passing time of the punching blade for each of said divisional control intervals,
compare the period of target passing time set for said divisional control interval and the period of measured passing time obtained by the actual measurement for each of said divisional control intervals or for every set-group of the divisional control intervals, and
control said motor for punching blade drive in a next interval of said divisional control intervals or in a next set-group of the divisional control intervals so as to be driven when, based on a result of the comparison, the period of measured passing time is longer than the period of target passing time or control said motor for punching blade drive in a next interval of said divisional control intervals or in a next set-group of the divisional control intervals so as to be braked when, based on a result of the comparison, the period of measured passing time is shorter than the period of target passing time, wherein the control device is further configured to:
measure a period of actual passing time of the punching blade for the specific interval just before said punching blade returns its home position;
calculate a reverse rotation brake force retain time based on the period of measured passing time of the punching blade;
perform a reverse rotation brake on said motor for the punching blade drive only for the reverse rotation brake force retain time when said punching blade returns its home position; and
perform a short brake on said motor for the punching blade drive to stop the punching blade.

2. The paper-sheet punching device according to claim 1, wherein said control device is also configured to monitor a rotation direction of said motor when prolonging the reverse rotation brake of said motor for the punching blade drive, and to stop said reverse rotation brake at the point of time when it is detected that the rotation direction of said motor changes.

3. A control method of a paper-sheet punching device including a motor for driving a reciprocatingly movable punching blade, having a home position of the punching blade and punching a hole through a predetermined paper-sheet, the method comprising:
a step of setting divisional control intervals by separating a specific interval during a period of return path time of the punching blade into a plurality of intervals;
a step of setting a period of target passing time of the punching blade for each of said divisional control intervals or for every set-group of the divisional control intervals so that the period of target passing time of the punching blade has a relationship such that the period of target passing time thereof corresponding to the specific interval which is close to the home position of the punching blade is longer than the period of target passing time thereof corresponding to the specific interval which is away from the home position of the punching blade;
a step of measuring a period of actual passing time of the punching blade for each of said divisional control intervals;
a step of comparing the period of target passing time set for said divisional control interval and the period of the measured passing time obtained by the actual measurement for each of said divisional control intervals or for every set-group of the divisional control intervals; and
a step of controlling said motor for the punching blade drive in a next interval of said divisional control intervals or in a next set-group of the divisional control intervals so as to be driven when, based on a result of the comparison, the period of measured passing time is longer than the period of target passing time, or said motor for the punching blade drive in a next interval of said divisional control intervals or in a next set-group of the divisional control intervals so as to braked when, based on a result of the comparison, the period of measured passing time is shorter than the period of target passing time, wherein the step of controlling said motor for the punching blade drive includes:
a sub-step of measuring a period of actual passing time of the punching blade for the specific interval just before said punching blade returns its home position;
a sub-step of calculates a reverse rotation brake force retain time based on the period of measured passing time of the punching blade;
a sub-step of performing a reverse rotation brake on said motor for the punching blade drive only for the reverse rotation brake force retain time when said punching blade returns its home position; and
a sub-step of performing a short brake on said motor for the punching blade drive to stop the punching blade.

4. The control method of a paper-sheet punching device according to claim 3, wherein the step of controlling said motor for the punching blade drive further includes a sub-step of monitoring a rotation direction of said motor when prolonging the reverse rotation brake of said motor for the punching blade drive, and a sub-step of stopping said reverse rotation brake at the point of time when it is detected that the rotation direction of said motor changes.
